(19) United States
(12) Patent Application Publication
(10) Pub. No.: US 2005/0189278 A1
(43) Pub. Date: Sep. 1, 2005

(54) Apparatus for decomposing organic matter with radical treatment method using electric discharge

(76) Inventors: Takanori Iijima, Fuchu-shi (JP); Takaaki Murata, Kawasaki-shi (JP); Kie Kubo, Machida-shi (JP); Yuji Okita, Kawasaki-shi (JP); Shinji Kobayashi, Yokohama-shi (JP); Toru Ebata, Hachioji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/047,761

(22) Filed: Feb. 2, 2005

(30) Foreign Application Priority Data
Feb. 3, 2004 (JP) 2004-026615
Mar. 16, 2004 (JP) 2004-075043
Apr. 16, 2004 (JP) 2004-121996
Jan. 7, 2005 (JP) 2005-002932

(51) Int. Cl. C02F 1/78

(52) U.S. Cl. 210/192; 210/205

(57) ABSTRACT

An apparatus performs radical treatment by electric discharge. The radical treatment apparatus includes an electrode unit having a gas flow path that blows gas onto treatment water and an electrode member that generates the electric discharge at a leading edge in order to generate a radical from the gas.

### CROSS-REFERENCE TO RELATED APPLICATIONS

This application is based upon and claims the benefit of priority from prior Japanese Patent Applications No. 2004-026615, filed Feb. 3, 2004; No. 2004-075043, filed Mar. 16, 2004; No. 2004-121996, filed Apr. 16, 2004; and No. 2005-002932, filed Jan. 7, 2005, the entire contents of all of which are incorporated herein by reference.

### BACKGROUND OF THE INVENTION

1. Field of the Invention

The present invention relates to an apparatus for water treatment using radical generated by electric discharge.

2. Description of the Related Art

Recently, in addition to the water treatment method using chlorine, the water treatment method using the oxidation reaction of ozone (O₃) is being applied. Both methods utilize the chemically strong oxidation power of an oxidant to decompose organic matter dissolved in the water.

In oxidation power, ozone is as high as 2.07 electron volts while chlorine is 1.4 electron volts. When chlorine reacts with the organic matter formed in high molecular compounds, by-products such as chloroprene, trihalomethane, haloacetic acid, haloketone, and haloacetonitrile are generated. In some of the by-products, the possibility of a cancer-causing substance is suggested. The by-products of disinfection are harmful to humans.

In contrast, because ozone is formed only by oxygen atoms, the environmental risk is small, and ozone is effective in decomposing the organic matter. Therefore, ozone is widely used in water treatment plants. This is the reason why recently the water treatment method using ozone has become widespread.

However, ozone cannot decompose recalcitrant organic matter like dioxins, agricultural chemicals, and endocrine-disruptors. Further, ozone reacts with organic matter to form aldehydes.

In order to decompose and treat recalcitrant organic matter by using chemical reaction, it is necessary to use an oxidant that has a higher oxidation potential than ozone. Specifically, a hydroxyl radical (OH radical) and an oxygen atom radical (O radical) have oxidation powers of 2.85 electron volts and 2.42 electron volts, respectively, and these values are higher than that of ozone. The OH radical and the O radical have a reaction rate coefficient higher than that of ozone for recalcitrant organic matter. Therefore, the OH radical and the O radical can decompose and treat recalcitrant organic matter like dioxins. Hereinafter the OH radical, the O radical, and the like are collectively called radicals.

The radicals are generated in the electric discharge under conditions of humidity and presence of oxygen. Conventionally, a treatment method using corona discharge to decompose harmful substances has been proposed (for example, see Jpn. Pat. Appln. KOKAI Publication No. 2001-70946).

A treatment method using reactive gas including radicals at low temperature is also proposed (for example, see Jpn. Pat. Appln. KOKAI Publications No. 2003-80059 and No. 2003-80058). Further, the treatment method using radicals generated by plasma in waste water to be treated has also been proposed (for example, see Jpn. Pat. Appln. KOKAI Publication No. 2000-288547).

The radicals obtained by the above-described electric discharge have extremely high reactivity, and are extinguished immediately after being generated. In order to decompose the recalcitrant organic matter dissolved in the water by using the radicals, it is necessary that the radicals be dissolved in the water immediately after being generated. Alternatively, it is necessary that the lifetime of the radicals be lengthened.

However, a technology that lengthens the lifetime of the generated radicals has not been established yet. Accordingly, even if the radical treatment method by electric discharge is simply applied to water treatment, there is a problem in that the efficiency of the water treatment is not so high.

### BRIEF SUMMARY OF THE INVENTION

In accordance with an aspect of the present invention, there is provided an apparatus that can improve efficiency of organic matter decomposing treatment in a radical treatment apparatus using electric discharge.

The apparatus for radical treatment comprises a gas unit to introduce gas for generating a radical; a power supply to produce an electric discharge by high voltage; and an electrode unit including an electrode member which discharges at a leading edge opposite to a treatment object matter, the electric discharge being generated according to the electric discharge high voltage in an atmosphere of the gas.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram for explaining a configuration of a water treatment apparatus according to a first embodiment of the invention;

FIG. 2 is a diagram for explaining a functional effect concerning the first embodiment;

FIG. 3 is a diagram for explaining a configuration of a water treatment apparatus according to a second embodiment of the invention;

FIG. 4 is a diagram for explaining a configuration of a water treatment apparatus according to a third embodiment of the invention;

FIG. 5 is a diagram for explaining a configuration of a water treatment apparatus according to a fourth embodiment of the invention;

FIG. 6 is a diagram for explaining a configuration of a water treatment apparatus according to a fifth embodiment of the invention;

FIG. 7 is a diagram for explaining a configuration of a water treatment apparatus according to a sixth embodiment of the invention;

FIG. 8 is a diagram for explaining a configuration of a water treatment apparatus according to a seventh embodiment of the invention;

FIG. 9 is a diagram for explaining a configuration of a water treatment apparatus according to an eighth embodiment of the invention;

FIG. 10 is a diagram for explaining a configuration of a water treatment apparatus according to a ninth embodiment of the invention;

FIG. 11 is a diagram for explaining a configuration of a water treatment apparatus according to a tenth embodiment of the invention;

FIG. 12 is a diagram for explaining a configuration of a water treatment apparatus according to an eleventh embodiment of the invention;

FIG. 13 is a diagram for explaining a configuration of a water treatment apparatus according to a twelfth embodiment of the invention;

FIG. 14 is a diagram for explaining a configuration of a water treatment apparatus according to a thirteenth embodiment of the invention;

FIG. 15 is a diagram for explaining a configuration of a water treatment apparatus according to a fourteenth embodiment of the invention;

FIG. 16 is a diagram for explaining a configuration of a water treatment apparatus according to a fifteenth embodiment of the invention;

FIG. 17 is a diagram for explaining a configuration of a water treatment apparatus according to a sixteenth embodiment of the invention;

FIG. 18 is a diagram for explaining a configuration of a water treatment apparatus according to a seventeenth embodiment of the invention;

FIG. 19 is a graph for explaining a functional effect of a water treatment apparatus according to an eighteenth embodiment of the invention;

FIG. 20 is a graph for explaining the functional effect of the water treatment apparatus according to the eighteenth embodiment;

FIG. 21 is a graph for explaining the functional effect of the water treatment apparatus according to the eighteenth embodiment;

FIG. 22 is a graph for explaining a functional effect of a water treatment apparatus according to a nineteenth embodiment of the invention;

FIG. 23 is a graph for explaining a functional effect of a water treatment apparatus according to a twentieth embodiment of the invention;

FIG. 24 is a graph for explaining a functional effect of a water treatment apparatus according to a twenty-first embodiment of the invention;

FIG. 25 is a graph for explaining the functional effect of the water treatment apparatus according to the twenty-first embodiment;

FIG. 26 is a graph for explaining a functional effect of a water treatment apparatus according to a twenty-second embodiment of the invention;

FIG. 27 is a diagram for explaining a configuration of a radical treatment apparatus according to a twenty-fourth embodiment of the invention;

FIG. 28 is a diagram for explaining a configuration of a gas supply apparatus according to the twenty-fourth embodiment;

FIG. 29 is a diagram for explaining a modification of the gas supply apparatus according to the twenty-fourth embodiment;

FIG. 30 is a view for explaining a structure of an electric discharge electrode according to the twenty-fourth embodiment;

FIGS. 31A and 31B are views for explaining the specific structure of the electric discharge electrode according to the twenty-fourth embodiment;

FIG. 32 is a view for explaining a structure of an electric discharge electrode according to a twenty-fifth embodiment of the invention;

FIG. 33 is a view for explaining a structure of an electric discharge electrode according to a twenty-sixth embodiment of the invention;

FIG. 34 is a diagram for explaining a configuration of a radical treatment apparatus according to a twenty-seventh embodiment of the invention;

FIG. 35 is a plan view showing the structure of a ground electrode according to the twenty-seventh embodiment;

FIG. 36 is a plan view showing a structure of a ground electrode according to a twenty-eighth embodiment of the invention;

FIG. 37 is a plan view showing a structure of a ground electrode according to a twenty-ninth embodiment of the invention;

FIGS. 38A and 38B show structures of an electrode member according to a modification of the twenty-fourth embodiment;

FIG. 39 is a diagram showing a radical treatment apparatus according to a thirtieth embodiment of the invention;

FIG. 40 is a graph showing pressure dependence of a change in OH radical concentration according to the thirtieth embodiment;

FIG. 41 is a graph showing a life of an OH radical according to the thirtieth embodiment;

FIG. 42 is a diagram showing a first modification of the thirtieth embodiment;

FIG. 43 is a diagram showing a second modification of the thirtieth embodiment;

FIG. 44 is a diagram showing a third modification of the thirtieth embodiment;

FIG. 45 is a diagram showing a fourth modification of the thirtieth embodiment;

FIG. 46 is a diagram showing a fifth modification of the thirtieth embodiment;

FIG. 47 is a diagram showing a sixth modification of the thirtieth embodiment;

FIG. 48 is a diagram showing a seventh modification of the thirtieth embodiment;

FIG. 49 is a diagram showing an example of a humidifier of the seventh modification;

FIG. 50 is a diagram showing an eighth modification of the thirtieth embodiment;

FIG. 51 is a diagram showing a ninth modification of the thirtieth embodiment;

FIG. 52 is a diagram showing a tenth modification of the thirtieth embodiment;

FIG. 53 is a diagram showing an eleventh modification of the thirtieth embodiment;

FIG. 54 is a diagram showing a twelfth modification of the thirtieth embodiment;

FIG. 55 is a diagram showing a thirteenth modification of the thirtieth embodiment;

FIG. 56 is a diagram showing a fourteenth modification of the thirtieth embodiment;

FIG. 57 is a diagram showing a fifteenth modification of the thirtieth embodiment; and

FIG. 58 is a sectional view showing the structure of an electrode that generates a plurality of electric discharges according to the thirtieth embodiment.

### DETAILED DESCRIPTION OF THE INVENTION

Referring to the accompanying drawings, preferred embodiments of the invention will be described below.

(First Embodiment)

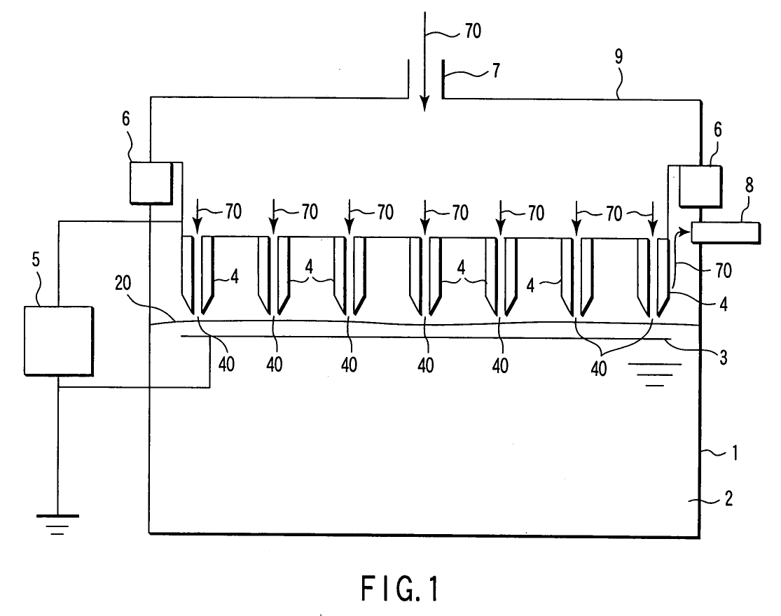

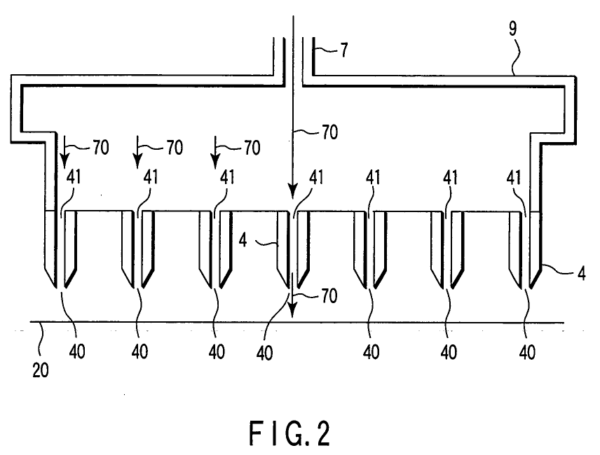

FIG. 1 shows a first embodiment in which an apparatus for decomposing organic matter by a radical treatment method is applied to a water treatment apparatus. FIG. 2 shows a partial configuration of the water treatment apparatus.

The main body of the apparatus is a treatment water tank 1 for storing treatment water 2 therein. A typical example of the treatment water 2 stored in the treatment water tank 1 includes the organic matter that is difficult to decompose. Examples of the treatment water 2 also include wastes, leaching water of a disposal site, dioxins, industrial wastewater, wastewater containing house drainage, and treatment water of clean water and sewage. Usually the treatment water 2 is stirred in the treatment water tank 1.

An electrode unit is provided in the treatment water tank 1. The electrode unit includes a plurality of first electrodes (projection members) 4 and a second electrode 3. The first electrodes 4 having hollow cylindrical structures are arranged near a surface (water surface) 20 of the treatment water 2, and the first electrodes 4 have electric discharge portions 40. The second electrode 3 is arranged in the treatment water 2, and the second electrode 3 constitutes a ground electrode.

In the electrode unit, a high voltage is applied between the first electrode 4 and the second electrode 3 from a power supply 5 to generate corona discharge. The electrode unit is attached to the treatment water tank 1 made of, for example, stainless steel through an insulating portion 6. It is possible that a pulse power supply that generates a high-voltage pulse is used as the power supply 5.

A gas tank 9 that accumulates gas 70 is provided on the treatment water tank 1. The gas tank 9 includes a gas inflow pipe 7 and a gas outflow pipe 8. The gas 70 that is of air containing moisture or oxygen flows into the gas tank 9 through the gas inflow pipe 7, and the gas 70 flows out of the gas tank 9 through the gas outflow pipe 8.

(Functional Effect of First Embodiment)

Referring to FIGS. 1 and 2, the functional effect of the apparatus according to the first embodiment will be described below.

The gas 70 such as air containing moisture is caused to flow in the gas tank 9 through the gas inflow pipe 7. As shown in FIG. 2, according to internal pressure of the gas tank 9, the gas 70 flows into gas flow paths 41 which are formed by the hollow portions of the first electrodes 4. In the gas tank 9, the gas 70 flows uniformly into the gas flow paths 41.

The first electrodes 4 are arranged on the water surface 20 of the treatment water 2 at even intervals, so that the gas 70 is evenly blown onto the water surface 20 of the treatment water 2. Therefore, the gas 70 can be efficiently blown onto the treatment water 2.

When the high voltage is applied to the electrode unit from the power supply 5, the electric discharge such as the corona discharge is occurred in the electric discharge portion 40 that is located at the tip of the first electrode 4. The electric discharge portion 40 is arranged near the water surface 20 of the treatment water 2. Accordingly, both the gas 70 from the gas flow path 41 and a radical generated by the electric discharge, portion 40 are blown so as to impinge on the water surface 20 of the treatment water 2.

As used herein, the term “radical” means a general term for the radicals, such as an OH radical, which is generated through a reaction of the gas 70 by the electric discharge.

Thus, according to the apparatus of the embodiment, before the radical generated by the electric discharge disappears, the radical can be dissolved in the treatment water 2 for a short time by actively blowing the gas 70 from the gas flow path 41 to the treatment water 2. Accordingly, the dissolved radical can react with the organic matter, which is dissolved in the water and difficult to decompose, to efficiently decompose the organic matter while the dissolved radical is in the valid state before disappearance.

Next, the principle of a process for generating the radical by the electric discharge from the electrode unit will be described.

When the electric discharge is occurred in an atmosphere of air containing oxygen (O atom), an oxygen atom O(³P) in a ground state or an oxygen atom O(¹D) in a excited energy level are generated by a collision between an electron e and a gas molecule in the electric discharge. This state is expressed by the following chemical formula (1):
e+O₂→O(¹D)+O(³P) (1)
wherein O(¹D) reacts with a water molecule. Then OH is produced. .OH means a hydroxyl radical (hereinafter referred to as OH radical) Namely, the following chemical formula (2) is valid:
O(¹D)+H₂O→2.OH (2)

The O(³P) atom generates ozone 03 by a triple collision of O(³P), an O₂ molecule, and a natural molecule M. Namely, the following chemical formula (3) is valid:
O(³P)+O₂+M→O₃+M (3)

A hydrogen atom H and the OH radical are generated by the direct collision between the water molecule and the electron. This state is expressed by the following chemical formula (4):
e+H₂O→H+.OH (4)

Hydrogen peroxide H₂O₂ is also generated from the OH radical. This state is expressed by the following chemical formula (5):
.OH+.OH→H₂O₂ (5)

The O atom, the OH radical, the ozone, and the hydrogen peroxide, which are generated above-described reactions, are dissolved into the treatment water by diffusion, and gas flow as the radical, thereby the treatment is performed.

In direct treatment, the OH radical generated by the electric discharge is dissolved into the treatment water 2, and the OH radical reacts immediately with the recalcitrant organic matter, and the OH radical resolve the organic matter to water H₂O, carbon dioxide CO₂, and hydrogen peroxide H₂O₂. This state is expressed by the following chemical formula (6):
.OH+R→H₂O+CO₂+H₂O₂ (6)

On the other hand, in indirect treatment, the OH radical is generated by the reaction of the ozone and hydrogen peroxide, which are generated from the electric discharge, and the OH radical resolves the recalcitrant organic matter.

When the hydrogen peroxide is dissolved in the water, the hydrogen peroxide is dissociated to form HO₂⁻ and a hydrogen ion H⁺. This state is expressed by the following chemical formula (7):
H₂O₂ [symbol] HO₂⁻+H⁺ (7)

The generated HO₂⁻ reacts with O₃ to form O₃⁻ and an HO₂ radical. This state is expressed by the following chemical formula (8):
HO₂⁻+O₃→O₃⁻+HO₂. (8)

The generated HO₂. is dissociated to form O₂⁻ and H⁺. This state is expressed by the following chemical formula (9):
HO₂. [symbol] O₂⁻+H⁺ (9)

The generated O₂⁻ reacts with the ozone to form O₃⁻. This state is expressed by the following chemical formula (10):
O₂⁻+O₃→O₃⁻+O₂ (10)

O₃⁻ reacts with H⁺ to form HO₃. This state is expressed by the following chemical formula (11):
O₃⁻+H⁺→HO₃ (11)

HO₃ is dissociated to form the OH radical. This state is expressed by the following chemical formula (12):
HO₃→.OH+O₂ (12)

Thus, the radicals generated by the electric discharge are dissolved into the treatment water 2, and the water treatment performed on the treatment water 2 by the radical in the two stages of the direct treatment and the indirect treatment.

(Second Embodiment)

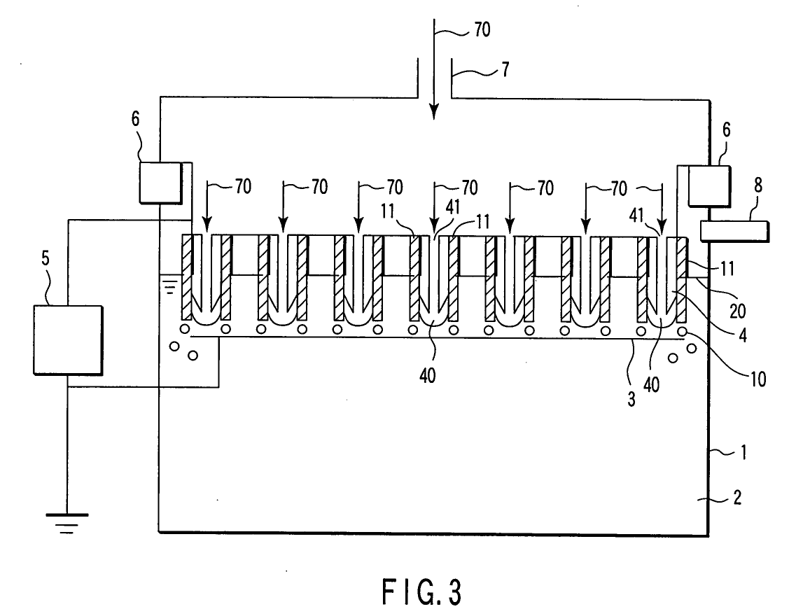

FIG. 3 is a diagram showing a configuration of a water treatment apparatus according to a second embodiment of the invention. In the second embodiment, the same configuration as the apparatus shown in FIGS. 1 and 2 is indicated by the same reference numerals, and the detailed description is neglected.

The apparatus of the second embodiment has a configuration in which a periphery of the hollow cylindrical structure main body having the gas flow path 41 is covered with a dielectric member 11 such as quartz glass in each first electrode 4. The electric discharge portion 40 located at the leading edge of each first electrode 4 is arranged in the treatment water 2. Because a gas space is formed at the leading edge of the first electrode 4, the leading edge is not in direct contact with the treatment water 2.

The functional effect of the second embodiment will be described below.

The gas 70 such as air containing moisture is caused to flow in the gas tank 9 through the gas inflow pipe 7. According to internal pressure of the gas tank 9, the gas 70 flows into the gas flow paths 41 of the first electrodes 4.

When the high voltage is applied to the electrode unit from the power supply 5, the electric discharge such as the corona discharge is generated in the electric discharge portion 40 located at the leading edge of the first electrode 4. Although the electric discharge portion 40 is arranged in the treatment water 2, a gas space is formed by the cover of the dielectric member 11 and the gas 70 blown so as to impinge in the treatment water 2 through the gas flow path 41. Namely, the electric discharge is generated at the portion 40 in the gas space formed at the leading edge of the first electrode 4.

In the electric discharge portion 40, the radical is generated from the gas 70 through the gas flow path 41 by the electric discharge. Both the radical and the gas 70 are blown into the treatment water 2. Therefore, bubbles 10 are generated by the gas 70 at the leading edge of the first electrode 4.

Thus, according to the second embodiment, the electric discharge portion 40 is arranged in the treatment water 2, so that the blown gas 70 and the radical can be dissolved into the treatment water 2 while the radical is in the valid state. Accordingly, the radical generated by the electric discharge can efficiently decompose the recalcitrant organic matter dissolved in the water.

(Third Embodiment)

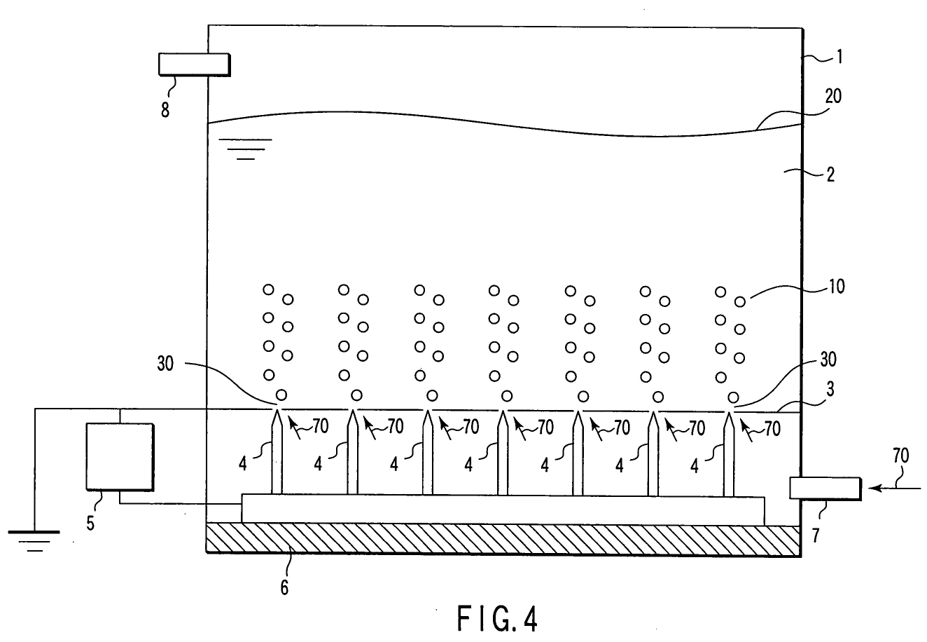

FIG. 4 is a diagram showing a configuration of a water treatment apparatus according to a third embodiment of the invention. In the third embodiment, the same configuration as the apparatus shown in FIGS. 1 and 2 is indicated by the same reference numerals, and the detailed description is neglected.

In the apparatus of the third embodiment, the electrode unit is provided in a lower chamber of the treatment water tank 1. The electrode unit includes the plurality of first electrodes 4 and the second electrode 3. The second electrode 3 constitutes the ground electrode, and is arranged in the treatment water 2. The electrode unit is attached to a bottom portion of the treatment water tank 1 made of, for example, stainless steel through the insulating portion 6.

The first electrode 4 includes a needle-shaped electrode member to which the high voltage necessary to the electric discharge is applied from the power supply 5. The second electrode 3 is formed by a plate member, and an opening 30 is formed at a position opposite to the leading edge of each first electrode 4. Since the gas space is formed at the leading edge of the first electrode 4, the leading edge is not in direct contact with the treatment water 2.

In the apparatus of the third embodiment, the lower chamber of the treatment water tank 1 in which the electrode unit is provided has the same structure as the gas tank 9 in which the gas inflow pipe 7 is provided.

The functional effect of the third embodiment will be described below.

The gas 70 such as air containing moisture is caused to flow in the lower chamber of the treatment water tank 1 through the gas inflow pipe 7. According to inflow pressure, the gas 70 is blown into the treatment water 2 from the openings 30 provided in the second electrode 3, which allows the gas space to be formed at the leading edge of the first electrode 4 opposite to the opening 30.

In this state, when the high voltage is applied to the electrode unit from the power supply 5, the electric discharge is generated from the leading edge of the first electrode 4. Accordingly, at the leading edge of the first electrode 4, the radical is generated by the electric discharge from the gas 70 flowing in from the gas inflow pipe 7. Both the radical and the gas 70 are blown into the treatment water 2 from the openings 30 provided in the second electrode 3. Therefore, the bubbles 10 are generated by the gas 70 at the leading edges of the first electrodes 4.

Thus, according to the third embodiment, the leading edge of the first electrode 4 which is of the portion as electric discharge is in the same state as the state in which the leading edge is arranged in the treatment water 2, so that the blown gas 70 and the radical can efficiently be dissolved into the treatment water 2. Accordingly, the radical can efficiently decompose the recalcitrant organic matter dissolved in the water.

Further, in the third embodiment, since the first electrode 4 to which the high voltage is applied is the needle-shaped (pin) electrode, an electric field can concentrate on the leading edge of the first electrode 4, which allows the electric discharge to be generated at a relatively low voltage.

(Fourth Embodiment)

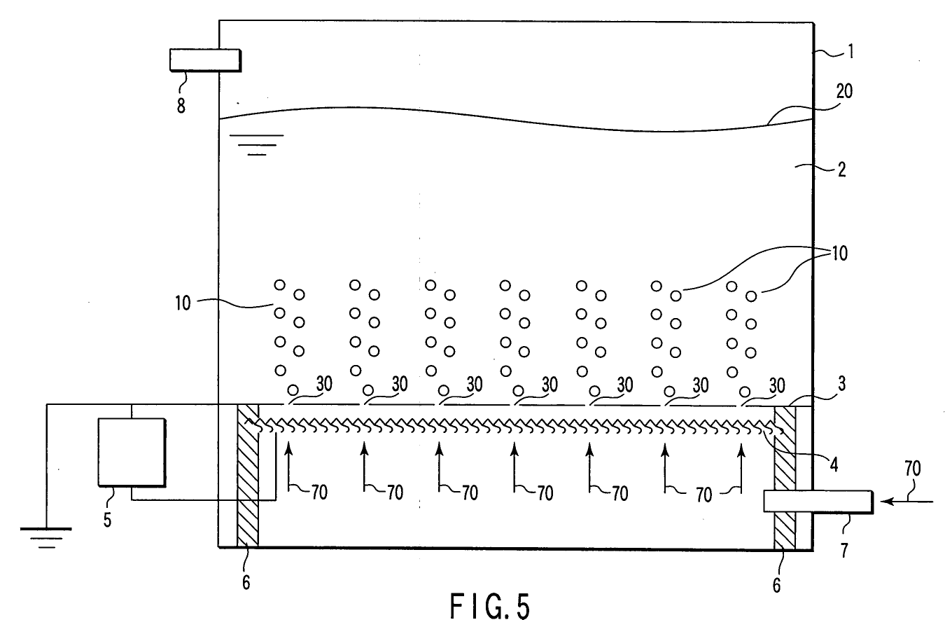

FIG. 5 is a diagram showing a configuration of a water treatment apparatus according to a fourth embodiment of the invention. In the fourth embodiment, the same configuration as the apparatus shown in FIGS. 1 and 4 is indicated by the same reference numerals, and the detailed description is neglected.

In the apparatus of the fourth embodiment, the electrode unit is provided in the lower chamber of the treatment water tank-1. The electrode unit includes the first electrode 4 and the second electrode 3. The second electrode 3 constitutes the ground electrode, and is arranged parallel to the first electrode 4 in the treatment water 2. As shown in FIG. 5, the electrode unit is attached to the treatment water tank 1 through the insulating portion 6.

The first electrode 4 of the fourth embodiment is formed by the electrode member having a metal mesh structure to which the high voltage necessary to the electric discharge is applied from the power supply 5. The second electrode 3 is formed by the plate-shaped member and arranged parallel to the first electrode 4, and the plurality of openings 30 are formed in the second electrode 3. Since the gas space is formed in the first electrode 4, the leading edge is not in direct contact with the treatment water 2.

In the apparatus of the fourth embodiment, the lower chamber of the treatment water tank 1 in which the electrode unit is provided has the same structure as the gas tank 9 in which the gas inflow pipe 7 is provided.

A functional effect of the fourth embodiment will be described below.

The gas 70 such as air containing moisture is caused to flow in the lower chamber of the treatment water tank 1 through the gas inflow pipe 7. According to the inflow pressure, the gas 70 is blown into the treatment water 2 from the mesh of the first electrode and the openings 30 provided in the second embodiment 3, which allows the gas space to be formed at the leading edge of the first electrode 4 near the openings 30.

In this state, when the high voltage is applied to the electrode unit from the power supply 5, the electric discharge is produced from the leading edge of the first electrode 4. Accordingly, at the leading edge of the first electrode 4, the radical is generated by the electric discharge from the gas 70 flowing in from the gas inflow pipe 7. Both the radical and the gas 70 are blown into the treatment water 2 from the openings 30 provided in the second electrode 3. Therefore, the bubbles 10 are generated by the gas 70 at the leading edges of the first electrodes 4.

Thus, according to the fourth embodiment, the leading edge of the first electrode 4 which is of the portion is in the same state as the state in which the leading edge is arranged in the treatment water 2, so that the radical can further efficiently be dissolved into the treatment water 2. Accordingly, the radical can efficiently decompose the recalcitrant organic matter dissolved in the water.

Further, in the fourth embodiment, since the first electrode 4 has the metal mesh structure, the electric discharge can be generated in the wide range, which allows electric discharge efficiency to be relatively improved.

(Fifth Embodiment)

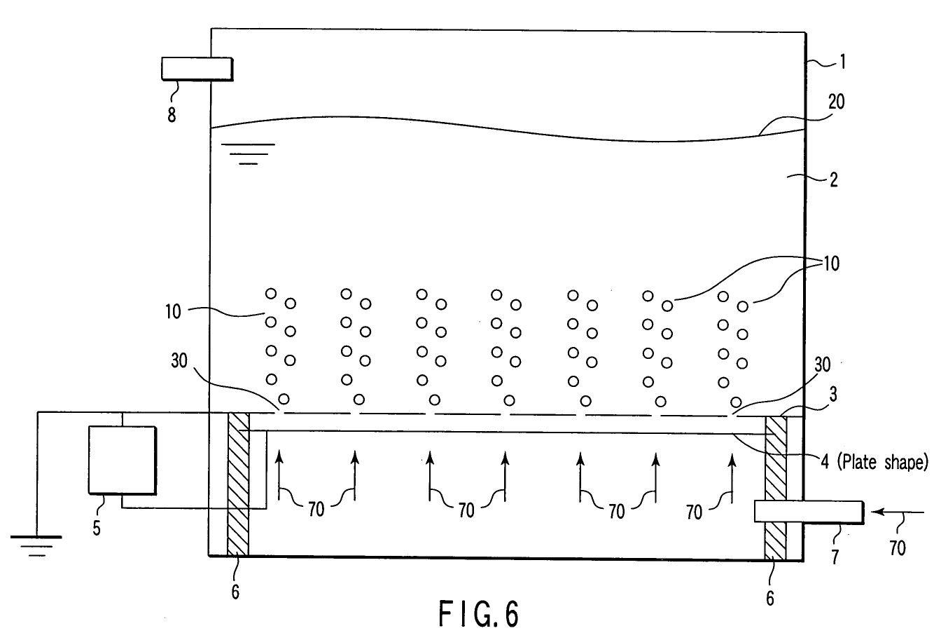

FIG. 6 is a diagram showing a configuration of a water treatment apparatus according to a fifth embodiment of the invention. In the fifth embodiment, the same configuration as the apparatus shown in FIGS. 1 and 5 is indicated by the same reference numerals, and the detailed description is neglected.

In the apparatus of the fifth embodiment, the electrode unit is provided in the lower chamber of the treatment water tank 1. The electrode unit includes the first electrode 4 and the second electrode 3. The second electrode 3 constitutes the ground electrode, and is arranged parallel to the first electrode 4 in the treatment water 2. As shown in FIG. 6, the electrode unit is attached to the treatment water tank 1 through the insulating portion 6.

The first electrode 4 of the fifth embodiment is formed by the plate-shaped electrode member to which the high voltage necessary to the electric discharge is applied from the power supply 5. The second electrode 3 is formed by the plate-shaped member, and the plurality of openings 30 are formed in the second electrode 3. Since the gas space is formed in the first electrode 4, the first electrode 4 is not in direct contact with the treatment water 2.

In the apparatus of the fifth embodiment, the lower chamber of the treatment water tank 1 in which the electrode unit is provided has the same structure as the gas tank 9 in which the gas inflow pipe 7 is provided.

The functional effect of the fifth embodiment will be described below.

The gas 70 such as air containing moisture is caused to flow in the lower chamber of the treatment water tank 1 through the gas inflow pipe 7. According to the inflow pressure, the gas 70 is blown into the treatment water 2 from the openings 30 provided in the second embodiment 3, which allows the gas space to be formed at a part of the first electrode 4, which is located near the opening 30.

In this state, when the high voltage is applied to the electrode unit from the power supply 5, the electric discharge is generated from the part of the first electrode 4. Accordingly, at the part of the first electrode 4, the radical is generated by the electric discharge from the gas 70 flowing in from the gas inflow pipe 7. Both the radical and the gas 70 are blown into the treatment water 2 from the openings 30 provided in the second electrode 3. Therefore, the bubbles 10 are generated by the gas 70 at the openings 30 provided in the second electrode 3.

Thus, according to the fifth embodiment, the first electrode 4 which is of the electric discharge portion is in the same state as the state in which the first electrode 4 is arranged in the treatment water 2, so that the radical can efficiently be dissolved into the treatment water 2. Accordingly, the radical can efficiently decompose the recalcitrant organic matter dissolved in the water.

(Sixth Embodiment)

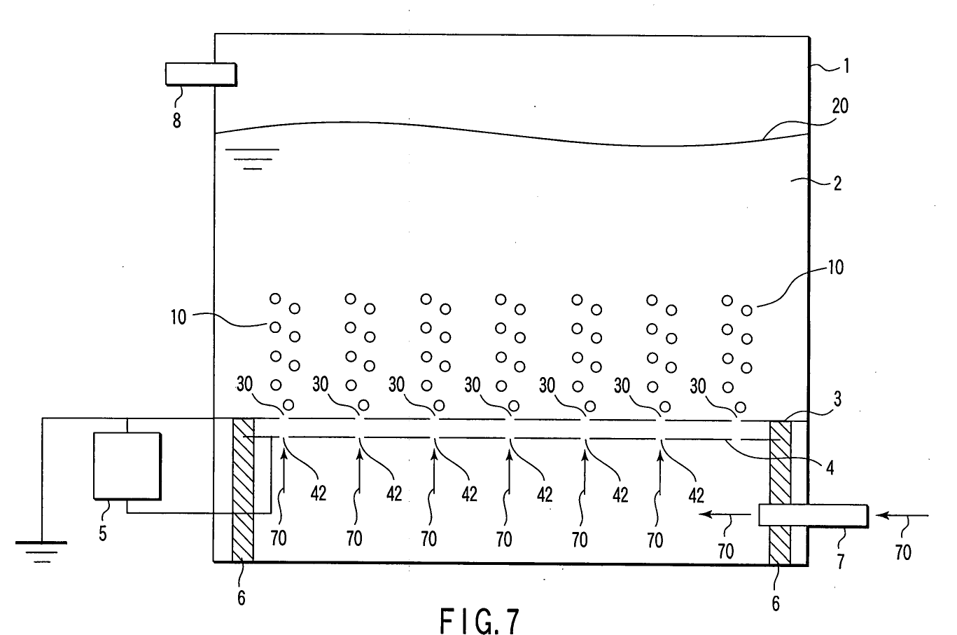

FIG. 7 is a diagram showing a configuration of a water treatment apparatus according to a sixth embodiment of the invention. In the sixth embodiment, the same configuration as the apparatus shown in FIGS. 1 and 6 is indicated by the same reference numerals, and the detailed description is neglected.

In the apparatus of the sixth embodiment, the electrode unit is provided in the lower chamber of the treatment water tank 1. The electrode unit includes the first electrode 4 and the second electrode 3. The second electrode 3 constitutes the ground electrode, and is arranged parallel to the first electrode 4 in the treatment water 2. As shown in FIG. 7, the electrode unit is attached to the treatment water tank 1 through the insulating portion 6.

The first electrode 4 of the sixth embodiment is formed by the plate-shaped electrode member to which the high voltage necessary to the electric discharge is applied from the power supply 5, and a plurality of openings 42 are formed in the first electrode 4. The second electrode 3 is formed by the plate-shaped member, and the plurality of openings 30 are formed in the second electrode 3. Since the gas space is formed in the first electrode 4, the first electrode 4 is not in direct contact with the treatment water 2.

In the apparatus of the sixth embodiment, the lower chamber of the treatment water tank 1 in which the electrode unit is provided has the same structure as the gas tank 9 in which the gas inflow pipe 7 is provided.

The functional effect of the sixth embodiment will be described below.

The gas 70 such as air containing moisture is caused to flow in the lower chamber of the treatment water tank 1 through the gas inflow pipe 7. According to the inflow pressure, the gas 70 is blown into the treatment water 2 from the openings 42 provided in the first electrode 4 and the openings 30 provided in the second embodiment 3, which allows the gas space to be formed at the openings 42 of the first electrode 4, which are located near the openings 30.

In this state, when the high voltage is applied to the electrode unit from the power supply 5, the electric discharge is generated from the openings 42 of the first electrode 4. Accordingly, at the openings 42 of the first electrode 4, the radical is generated by the electric discharge from the gas 70 flowing in from the gas inflow pipe 7. Both the radical and the gas 70 are blown into the treatment water 2 from the openings 30 provided in the second electrode 3. Therefore, the bubbles 10 are generated by the gas 70 at the openings 30 provided in the second electrode 3.

Thus, according to the sixth embodiment, the first electrode 4 which is of the electric discharge portion is in the same state as the state in which the first electrode 4 is arranged in the treatment water 2, so that the radical can efficiently be dissolved into the treatment water 2. Accordingly, the recalcitrant organic matter dissolved in the water can efficiently be decomposed by the radical.

(Seventh Embodiment)

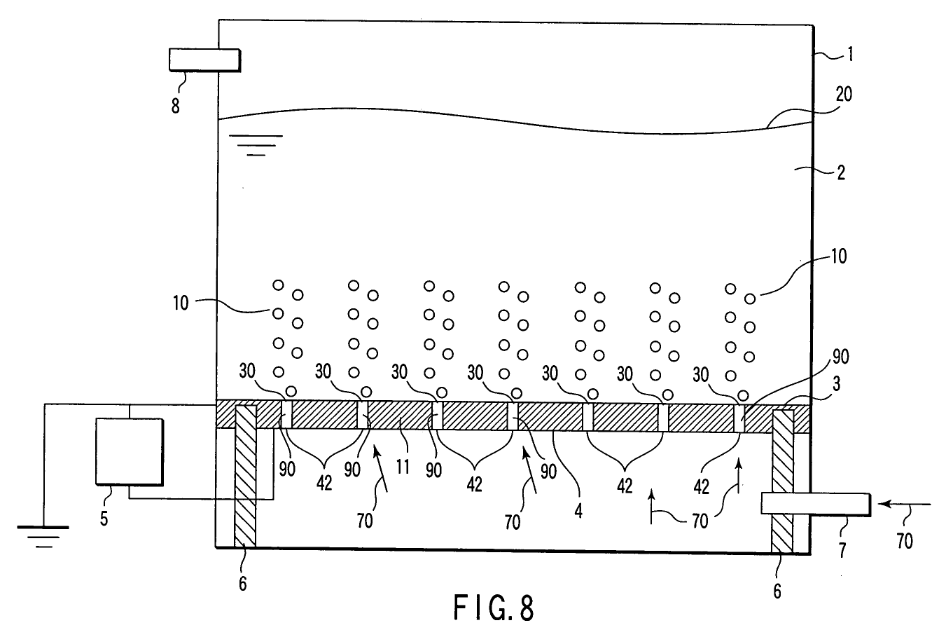

FIG. 8 is a diagram showing a configuration of a water treatment apparatus according to a seventh embodiment of the invention. In the seventh embodiment, the same configuration as the apparatus shown in FIGS. 1 and 7 are indicated by the same reference numerals, and the detailed description is neglected.

In the apparatus of the seventh embodiment, the electrode unit is provided in the lower chamber of the treatment water tank 1. The electrode unit includes the first electrode 4, the dielectric member 11 made of the quartz glass, and the second electrode 3. The second electrode 3 constitutes the ground electrode, and is arranged parallel to the first electrode 4 in the treatment water 2. As shown in FIG. 8, the electrode unit is attached to the treatment water tank 1 through the insulating portion 6.

The electrode unit of the seventh embodiment includes the first electrode 4 and the dielectric member 11. The high voltage to occur the electric discharge is applied from the power supply 5 to the first electrode 4. The dielectric member 11 is located between the plate-shaped first electrode 4 and the plate-shaped second electrode 3 arranged in parallel with the first electrode 4. Through-holes 90 which pierce through the first electrode 4, the dielectric material 11, and the second electrode 3 are made in the electrode unit. The through-hole 90 forms the gas flow path which blows the gas 70 from the opening 42 located on the side of the first electrode 4 to the opening 30 located on the side of the second electrode 3. Since the gas space is formed in the through-hole 90, the through-hole 90 is not in direct contact with the treatment water 2.

In the apparatus of the seventh embodiment, the lower chamber of the treatment water tank 1 in which the electrode unit is provided has the same structure as the gas tank 9 in which the gas inflow pipe 7 is provided.

The functional effect of the seventh embodiment will be described below.

The gas 70 such as air containing moisture is caused to flow in the lower chamber of the treatment water tank 1 through the gas inflow pipe 7. According to the inflow pressure, the gas 70 flows into the through-holes 90 from the openings 42 provided in the first electrode 4, and the gas 70 is blown into the treatment water 2 from the openings 30 provided in the second electrode 3, which allows the gas space to be formed in the through-hole 90.

In this state, when the high voltage is applied to the electrode unit from the power supply 5, the electric discharge is generated from the through-holes 90. Accordingly, in the through-hole 90, the radical is generated by the electric discharge from the gas 70 flowing in from the gas inflow pipe 7. Both the radical and the gas 70 are blown into the treatment water 2 from the openings 30 provided in the second electrode 3. Therefore, the bubbles 10 are generated by the gas 70 at the openings 30 provided in the second electrode 3.

Thus, according to the seventh embodiment, the through-hole 90 which is of the electric discharge portion is in the same state as the state in which the first electrode 4 is arranged in the treatment water 2, so that the radical can efficiently be dissolved into the treatment water 2. Accordingly, the recalcitrant organic matter dissolved in the water can efficiently be decomposed by the radical.

(Eighth Embodiment)

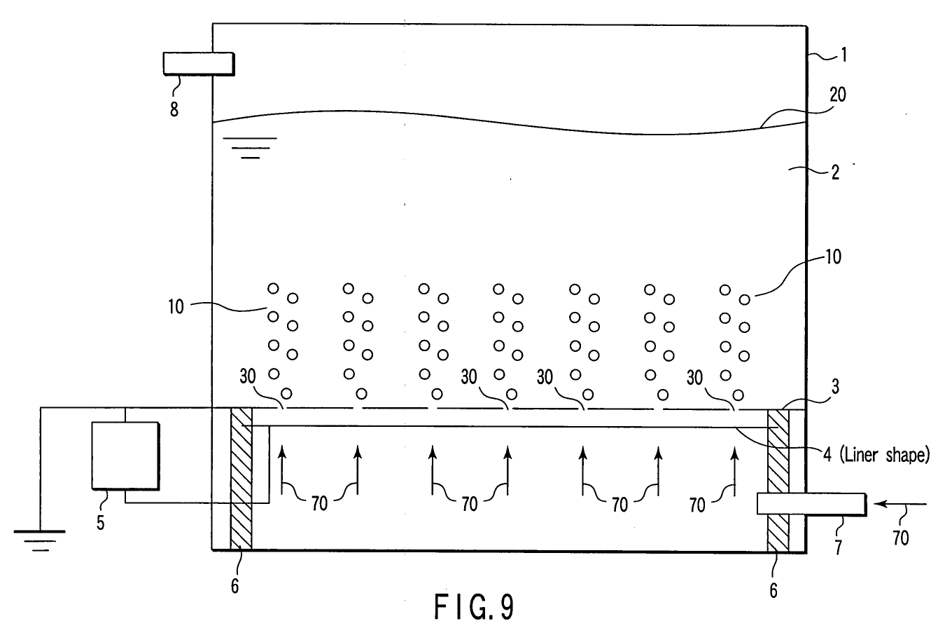

FIG. 9 is a diagram showing a configuration of a water treatment apparatus according to an eighth embodiment of the invention. In the eighth embodiment, the same configuration as the apparatus shown in FIGS. 1 and 6 is indicated by the same reference numerals, and the detailed description is neglected.

In the apparatus of the eighth embodiment, the electrode unit is provided in the lower chamber of the treatment water tank 1. The electrode unit includes the first electrode 4 and the second electrode 3. The second electrode 3 constitutes the ground electrode, and is arranged parallel to the first electrode 4 in the treatment water 2. As shown in FIG. 9, the electrode unit is attached to the treatment water tank 1 through the insulating portion 6.

The first electrode 4 of the eighth embodiment is formed by the linear electrode member (wire electrode) to which the high voltage necessary to the electric discharge is applied from the power supply 5. The second electrode 3 is formed by the plate-shaped member, and the plurality of openings 30 are formed in the second electrode 3.

In the apparatus of the eighth embodiment, the lower chamber of the treatment water tank 1 in which the electrode unit is provided has the same structure as the gas tank 9 in which the gas inflow pipe 7 is provided.

The functional effect of the eighth embodiment will be described below.

The gas 70 such as air containing moisture is caused to flow in the lower chamber of the treatment water tank 1 through the gas inflow pipe 7. According to the inflow pressure, the gas 70 is blown into the treatment water 2 from the openings 30 provided in the second embodiment 3, which allows the gas space to be formed at a part of the first electrode 4, which is located near the opening 30.

In this state, when the high voltage is applied to the electrode unit from the power supply 5, the electric discharge is generated from the part of the first electrode 4. Accordingly, at the part of the first electrode 4, the radical is generated by the electric discharge from the gas 70 flowing in from the gas inflow pipe 7. Both the radical and the gas 70 are blown into the treatment water 2 from the openings 30 provided in the second electrode 3. Therefore, the bubbles 10 are generated by the gas 70 at the openings 30 provided in the second electrode 3.

Thus, according to the eighth embodiment, the first electrode 4 which is of the electric discharge portion is in the same state as the state in which the first electrode 4 is arranged in the treatment water 2, so that the radical can efficiently be dissolved into the treatment water 2. Accordingly, the recalcitrant organic matter dissolved in the water can efficiently be decomposed by the radical.

(Ninth Embodiment)

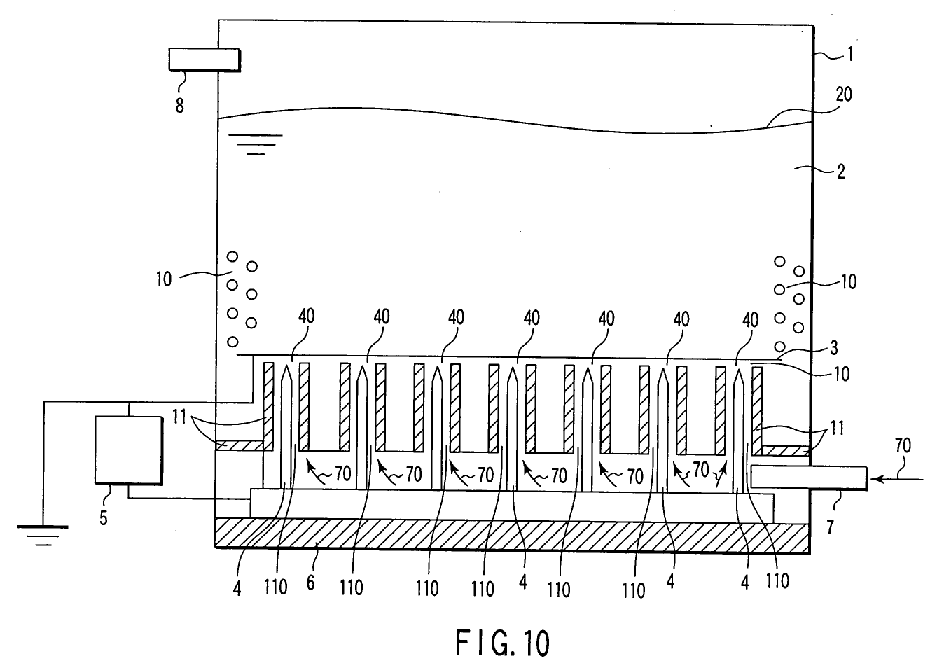

FIG. 10 is a diagram showing a configuration of a water treatment apparatus according to a ninth embodiment of the invention. In the ninth embodiment, the same configuration as the apparatus shown in FIGS. 1 and 4 is indicated by the same reference numerals, and the detailed description is neglected.

In the apparatus of the ninth embodiment, the electrode unit is provided in the lower chamber of the treatment water tank 1. The electrode unit includes the plurality of first electrodes 4 and the plate-shaped second electrode 3. The second electrode 3 constitutes the ground electrode, and is arranged in the treatment water 2. The electrode unit is attached to the bottom portion of the treatment water tank 1 made of, for example, a corrosion resistant metal material such as stainless steel through the insulating portion 6.

The first electrode 4 includes the needle-shaped electrode member to which the high voltage necessary to the electric discharge is applied from the power supply 5, and the periphery of the electrode member is covered with the dielectric member 11 made of, for example, quartz glass. In the first electrode 4, a gas flow path 110 through which the gas 70 flows is formed between the dielectric member 11 and the needle-shaped electrode member.

In the apparatus of the ninth embodiment, the lower chamber of the treatment water tank 1 in which the electrode unit is provided has the same structure as the gas tank 9 in which the gas inflow pipe 7 is provided.

The functional effect of the third embodiment will be described below.

The gas 70 such as air containing moisture is caused to flow in the lower chamber of the treatment water tank 1 through the gas inflow pipe 7. According to the inflow pressure, the gas 70 is blown into the treatment water 2 from the gas flow paths 110 provided in the first electrode 4, which allows the gas space to be formed at the leading edge (electric discharge portion 40) of the first electrode 4 opposite to the second electrode 3, and the leading edge is not in direct contact with the treatment water 2.

In this state, when the high voltage is applied to the electrode unit from the power supply 5, the electric discharge is generated from the electric discharge portion 40 that is of the leading edge of the first electrode 4. Accordingly, at the leading edge of the first electrode 4, the radical is generated by the electric discharge from the gas 70 flowing in from the gas inflow pipe 7. Both the radical and the gas 70 are blown into the treatment water 2. Therefore, the bubbles 10 are generated by the gas 70 near the leading edges of the first electrodes 4.

Thus, according to the ninth embodiment, the leading edge of the first electrode 4 which is of the electric discharge portion 40 is in the same state as the state in which the leading edge is arranged in the treatment water 2, so that the radical can efficiently be dissolved into the treatment water 2. Accordingly, the radical can efficiently decompose the recalcitrant organic matter dissolved in the water.

(Tenth Embodiment)

FIG. 11 is a diagram showing a configuration of a water treatment apparatus according to a tenth embodiment of the invention. In the tenth embodiment, the same configuration as the apparatus shown in FIGS. 1 and 10 is indicated by the same reference numerals, and the detailed description is neglected.

In the structure of the electrode unit according to the tenth embodiment, the needle-shaped electrode member that is arranged in a through-hole 120 forms the first electrode 4. The through-hole 120 is made in a glass member 12 that is arranged parallel to the second electrode 3. The first electrode 4 has the structure, in which the space between the needle-shaped electrode members is eliminated and the treatment water 2 does not enter the space. The through-hole 120 corresponds to the gas flow path 110 shown in FIG. 10, through which the gas 70 flows.

The functional effect of the third embodiment will be described below.

The gas 70 such as air containing moisture is caused to flow in the lower chamber of the treatment water tank 1 through the gas inflow pipe 7. According to the inflow pressure, the gas 70 is blown into the treatment water 2 from the through-holes 120 provided in the glass member 12, which allows the gas space to be formed at the leading edge (electric discharge portion 40) of the first electrode 4 opposite to the second electrode 3, and the leading edge is not in direct contact with the treatment water 2.

In this state, when the high voltage is applied to the electrode unit from the power supply 5, the electric discharge is generated from the electric discharge portion 40 that is of the leading edge of the first electrode 4. Accordingly, at the leading edge of the first electrode 4, the radical is generated by the electric discharge from the gas 70 flowing in the through-hole 120 from the gas inflow pipe 7. Both the radical and the gas 70 are blown into the treatment water 2. Therefore, the gas 70 near the leading edges of the first electrodes 4 generates the bubbles 10.

Thus, according to the tenth embodiment, the leading edge of the first electrode 4 which is of the electric discharge portion 40 is in the same state as the state in which the leading edge is arranged in the treatment water 2, so that the radical can efficiently be dissolved into the treatment water 2. Accordingly, the radical can efficiently decompose the recalcitrant organic matter dissolved in the water.

(Eleventh Embodiment)

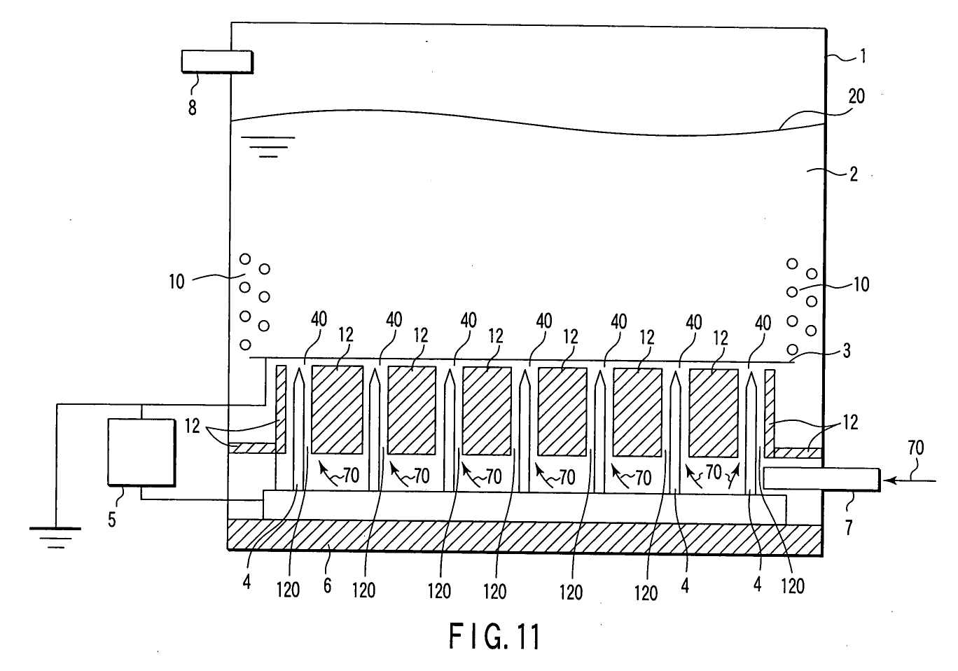

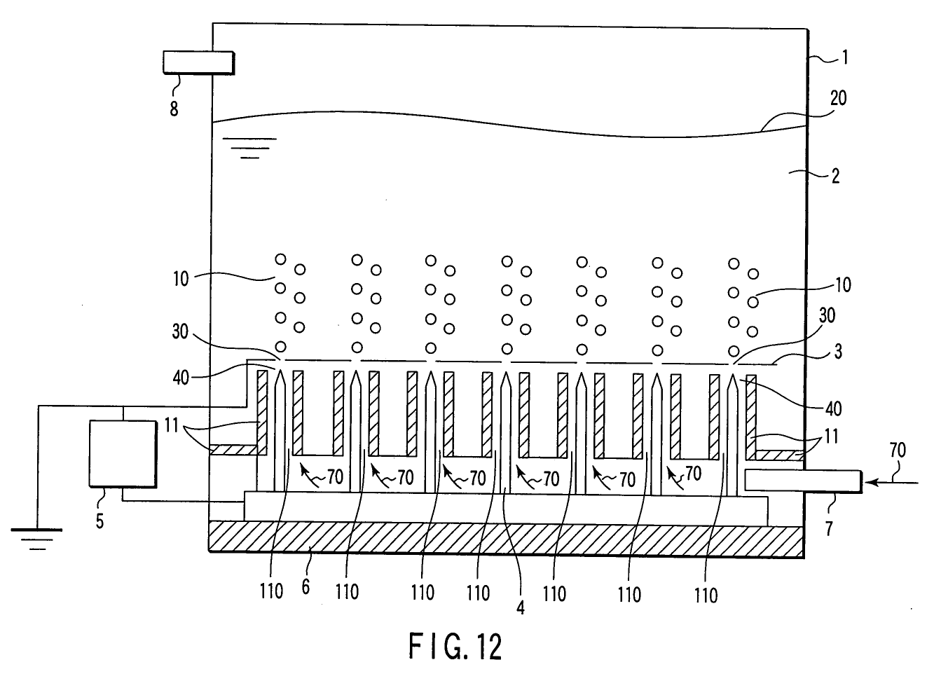

FIG. 12 is a diagram showing a configuration of a water treatment apparatus according to an eleventh embodiment of the invention. In the eleventh embodiment, the same configuration as the apparatus shown in FIGS. 1 and 10 is indicated by the same reference numerals, and the detailed description is neglected.

In the apparatus of the eleventh embodiment, the electrode unit is provided in the lower chamber of the treatment water tank 1. The electrode unit includes the plurality of first electrodes 4 and the plate-shaped second electrode 3. The second electrode 3 constitutes the ground electrode, and is arranged in the treatment water 2. In the second electrode 3, the plurality of openings 30 are formed at the position opposite to the leading edges of the first electrodes 4 (electric discharge portions 40).

The first electrode 4 is formed by the needle-shaped electrode member to which the high voltage necessary to the electric discharge is applied from the power supply 5, and the periphery of the electrode member is covered with the dielectric member 11 made of, for example, quartz glass. In the first electrode 4, the gas flow path 110 through which the gas 70 flows is formed between the dielectric member 11 and the needle-shaped electrode member.

The electrode unit is attached to the bottom portion of the treatment water tank 1 made of, for example, stainless steel through the insulating portion 6. In the apparatus of the eleventh embodiment, the lower chamber of the treatment water tank 1 in which the electrode unit is provided has the same structure as the gas tank 9 in which the gas inflow pipe 7 is provided.

The functional effect of the eleventh embodiment will be described below.

The gas 70 such as air containing moisture is caused to flow in the lower chamber of the treatment water tank 1 through the gas inflow pipe 7. According to inflow pressure, the gas 70 passes through the gas flow path 110 provided in the first electrode 4, and the gas 70 is blown into the treatment water 2 from the openings 30 provided in the second electrode 3, which allows the gas space to be formed at the leading edge of the first electrode 4 (electric discharge portion 40) opposite to the second electrode 3, and the leading edge is not in direct contact with the treatment water 2.

In this state, when the high voltage is applied to the electrode unit from the power supply 5, the electric discharge is generated from the electric discharge portion 40 that is of the leading edge of the first electrode 4. Accordingly, at the leading edge of the first electrode 4, the radical is generated by the electric discharge from the gas 70 flowing in the gas flow path 110 from the gas inflow pipe 7. Both the radical and the gas 70 are blown into the treatment water 2 from the openings 30 provided in the second electrode 3. Therefore, the bubbles 10 are generated near the opening 30 by the gas 70.

Thus, according to the eleventh embodiment, the leading edge of the first electrode 4 which is of the electric discharge portion 40 is in the same state as the state in which the leading edge is arranged in the treatment water 2, so that the radical can efficiently be dissolved into the treatment water 2. Accordingly, the radical can efficiently decompose the recalcitrant organic matter dissolved in the water.

(Twelfth Embodiment)

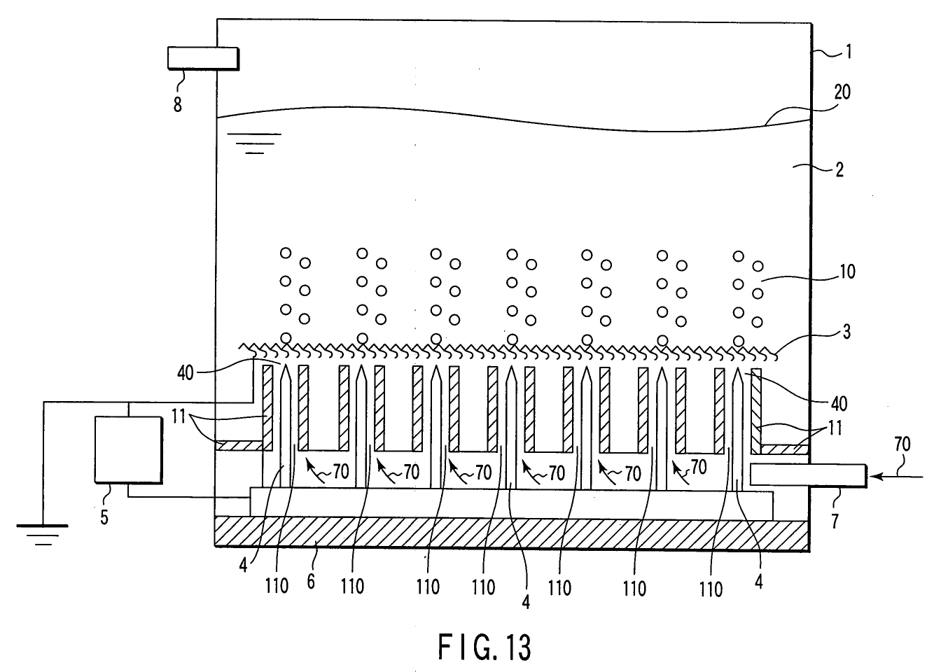

FIG. 13 is a diagram showing a configuration of a water treatment apparatus according to a twelfth embodiment of the invention. In the twelfth embodiment, the same configuration as the apparatus shown in FIGS. 1 and 10 is indicated by the same reference numerals, and the detailed description is neglected.

In the apparatus of the twelfth embodiment, the electrode unit is provided in the lower chamber of the treatment water tank 1. The electrode unit includes the plurality of first electrodes 4 and the second electrode 3 having the metal mesh structure. The second electrode 3 constitutes the ground electrode, and is arranged in the treatment water 2. The second electrode 3 is arranged at the position opposite to the leading edge of the first electrode 4 (electric discharge portion 40).

The first electrode 4 is formed by the needle-shaped electrode member to which the high voltage necessary to the electric discharge is applied from the power supply 5, and the periphery of the electrode member is covered with the dielectric member 11 made of, for example, quartz glass. In the first electrode 4, the gas flow path 110 through which the gas 70 flows is formed between the dielectric member 11 and the needle-shaped electrode member.

The electrode unit is attached to the bottom portion of the treatment water tank 1 made of, for example, stainless steel through the insulating portion 6. In the apparatus of the twelfth embodiment, the lower chamber of the treatment water tank 1 in which the electrode unit is provided has the same structure as the gas tank 9 in which the gas inflow pipe 7 is provided.

The functional effect of the twelfth embodiment will be described below.

The gas 70 such as air containing moisture is caused to flow in the lower chamber of the treatment water tank 1 through the gas inflow pipe 7. According to inflow pressure, the gas 70 passes through the gas flow path 110 provided in the first electrode 4, and the gas 70 is blown into the treatment water 2 from the mesh of the second electrode 3, which allows the gas space to be formed at the leading edge of the first electrode 4 (electric discharge portion 40) opposite to the second electrode 3, and the leading edge is not in direct contact with the treatment water 2.

In this state, when the high voltage is applied to the electrode unit from the power supply 5, the electric discharge is generated from the electric discharge portion 40 that is of the leading edge of the first electrode 4. Accordingly, at the leading edge of the first electrode 4, the radical is generated by the electric discharge from the gas 70 flowing in the gas flow path 110 from the gas inflow pipe 7. Both the radical and the gas 70 are blown into the treatment water 2 from the mesh of the second electrode 3. Therefore, the bubbles 10 are generated near the second electrode 3 by the gas 70.

Thus, according to the twelfth embodiment, the leading edge of the first electrode 4 which is of the electric discharge portion 40 is in the same state as the state in which the leading edge is arranged in the treatment water 2, so that the radical can efficiently be dissolved into the treatment water 2. Accordingly, the recalcitrant organic matter dissolved in the water can efficiently be decomposed by the radical.

(Thirteenth Embodiment)

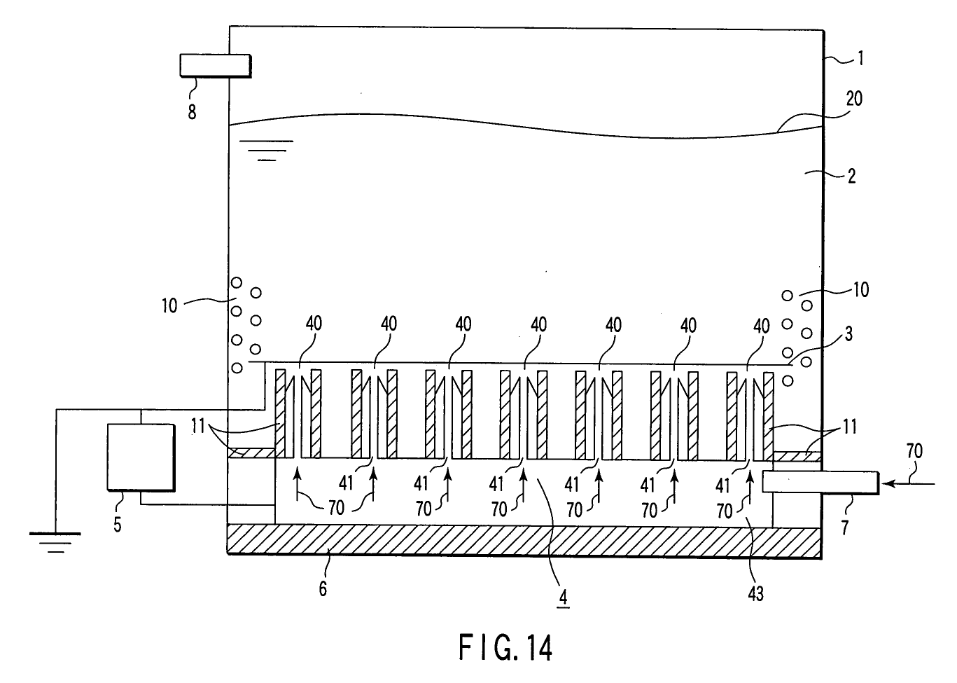

FIG. 14 is a diagram showing a configuration of a water treatment apparatus according to a thirteenth embodiment of the invention. In the thirteenth embodiment, the same configuration as the apparatus shown in FIGS. 3 and 10 is indicated by the same reference numerals, and the detailed description is neglected.

In the apparatus of the thirteenth embodiment, the electrode unit is provided in the lower chamber of the treatment water tank 1. The electrode unit includes the plurality of first electrodes 4 and the plate-shaped second electrode 3. The second electrode 3 constitutes the ground electrode, and is arranged in the treatment water 2. The electrode unit is attached to the bottom portion of the treatment water tank 1 made of, for example, stainless steel through the insulating portion 6.

The first electrode 4 includes the electrode member having the hollow cylindrical structure, to which the high voltage necessary to the electric discharge is applied from the power supply 5, and the first electrode 4 has the gas flow path 41 formed by the hollow portion. In the first electrode 4, the periphery of the electrode member is covered with the dielectric member 11 made of, for example, quartz glass. The electric discharge portion 40 located at the leading edge of each first electrode 4 is arranged in the treatment water 2.

In the apparatus of the thirteenth embodiment, the lower chamber of the treatment water tank 1 in which the electrode unit is provided has the same structure as the gas tank 9 in which the gas inflow pipe 7 is provided.

The functional effect of the thirteenth embodiment will be described below.

The gas 70 such as air containing moisture is caused to flow in the lower chamber of the treatment water tank 1 through the gas inflow pipe 7. According to the inflow pressure, the gas 70 is blown into the treatment water 2 from the gas flow paths 41 provided in the first electrode 4, which allows the gas space to be formed at the leading edge of the first electrode 4 (electric discharge portion 40) opposite to the second electrode 3, and the leading edge is not in direct is contact with the treatment water 2.

In this state, when the high voltage is applied to the electrode unit from the power supply 5, the electric discharge is generated from the electric discharge portion 40 that is of the leading edge of the first electrode 4. Accordingly, at the leading edge of the first electrode 4, the radical is generated by the electric discharge from the gas 70 flowing in the gas flow paths 41 from the gas inflow pipe 7. Both the radical and the gas 70 are blown into the treatment water 2 from the openings 30 provided in the second electrode 3. Therefore, the gas 70 near the leading edges of the first electrodes 4 generates the bubbles 10.

Thus, according to the thirteenth embodiment, the leading edge of the first electrode 4 which is of the electric discharge portion 40 is in the same state as the state in which the leading edge is arranged in the treatment water 2, so that the radical can efficiently be dissolved into the treatment water 2. Accordingly, the radical can efficiently decompose the recalcitrant organic matter dissolved in the water.

(Fourteenth Embodiment)

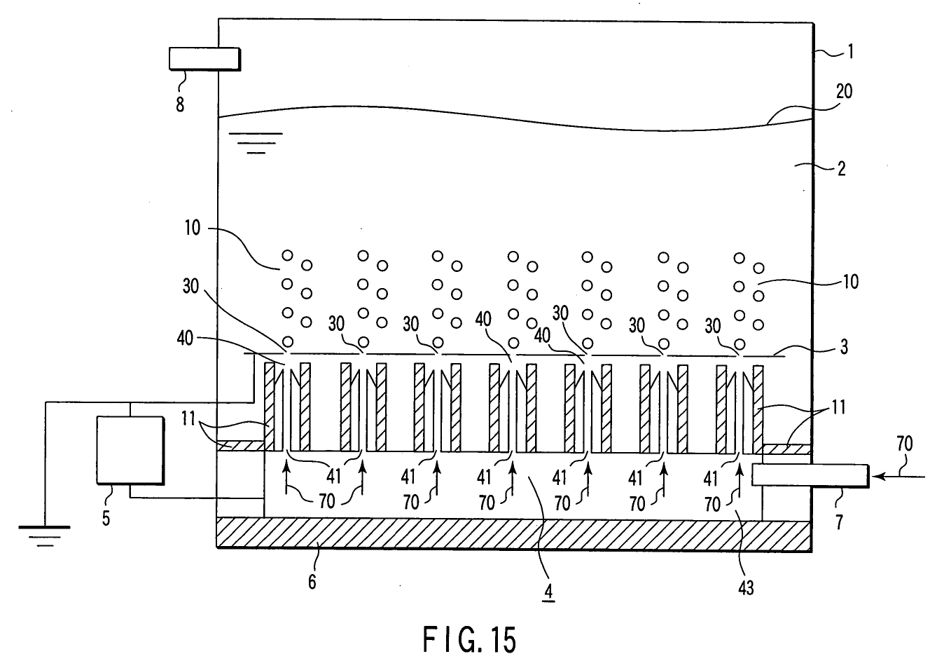

FIG. 15 is a diagram showing a configuration of a water treatment apparatus according to a fourteenth embodiment of the invention. In the fourteenth embodiment, the same configuration as the apparatus shown in FIGS. 3 and 14 is indicated by the same reference numerals, and the detailed description is neglected.

In the apparatus of the fourteenth embodiment, the electrode unit is provided in the lower chamber of the treatment water tank 1. The electrode unit includes the plurality of first electrodes 4 and the plate-shaped second electrode 3. The second electrode 3 constitutes the ground electrode, and is arranged in the treatment water 2. In the second electrode 3, the plurality of openings 30 are formed at the positions opposite to the leading edges of the first electrode 4 (electric discharge portion 40). The electrode unit is attached to the bottom portion of the treatment water tank 1 made of, for example, stainless steel through the insulating portion 6.

The first electrode 4 includes the electrode member having the hollow cylindrical structure, to which the high voltage necessary to the electric discharge is applied from the power supply 5, and the first electrode 4 has the gas flow path 41 formed by the hollow portion. In the first electrode 4, the periphery of the electrode member is covered with the dielectric member 11 made of, for example, quartz glass. The electric discharge portion 40 located at the leading edge of each first electrode 4 is arranged in the treatment water 2.

In the apparatus of the fourteenth embodiment, the lower chamber of the treatment water tank 1 in which the electrode unit is provided has the same structure as the gas tank 9 in which the gas inflow pipe 7 is provided.

The functional effect of the fourteenth embodiment will be described below.

The gas 70 such as air containing moisture is caused to flow in the lower chamber of the treatment water tank 1 through the gas inflow pipe 7. According to the inflow pressure, the gas 70 passes through the gas flow paths 41 provided in the first electrode 4, and the gas 70 is blown into the treatment water 2 from the openings 30 of the second electrode 3, which allows the gas space to be formed at the leading edge of the first electrode 4 (electric discharge portion 40) opposite to the second electrode 3, and the leading edge is not in direct contact with the treatment water 2.

In this state, when the high voltage is applied to the electrode unit from the power supply 5, the electric discharge is generated from the electric discharge portion 40 that is of the leading edge of the first electrode 4. Accordingly, at the leading edge of the first electrode 4, the radical is generated by the electric discharge from the gas 70 flowing in the gas flow paths 41 from the gas inflow pipe 7. Both the radical and the gas 70 are blown into the treatment water 2 from the openings 30 provided in the second electrode 3 so as to impinge on the water. Therefore, the bubbles 10 are generated near the opening 30 by the gas 70.

Thus, according to the fourteenth embodiment, the leading edge of the first electrode 4 which is of the electric discharge portion 40 is in the same state as the state in which the leading edge is arranged in the treatment water 2, so that the blown gas 70 and the radical can efficiently be dissolved into the treatment water 2. Accordingly, the radical can efficiently decompose the recalcitrant organic matter dissolved in the water.

(Fifteenth Embodiment)

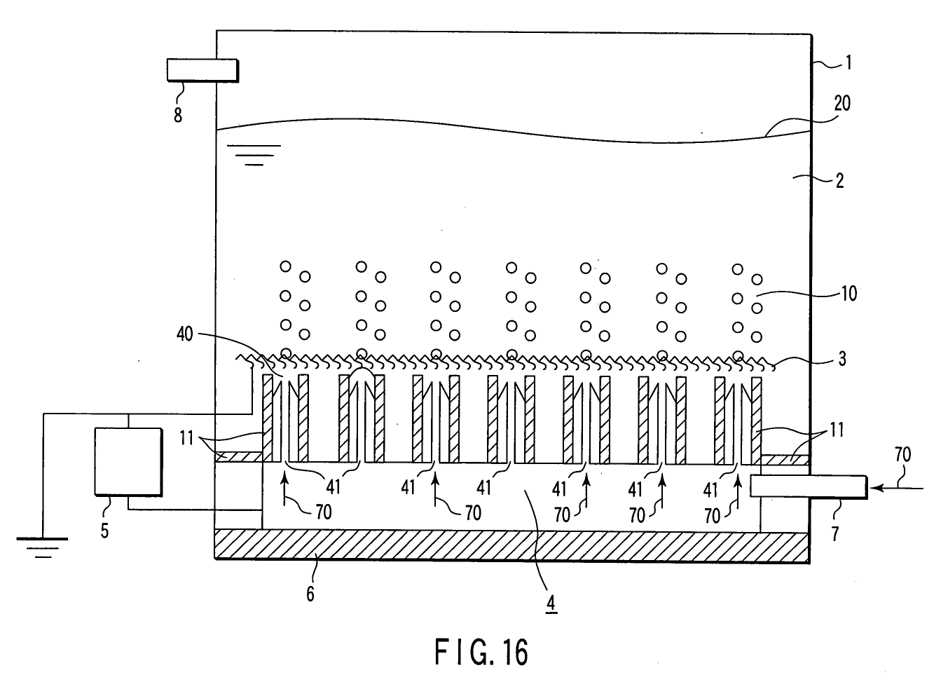

FIG. 16 is a diagram showing a configuration of a water treatment apparatus according to a fifteenth embodiment of the invention. In the fifteenth embodiment, the same configuration as the apparatus shown in FIGS. 3 and 14 is indicated by the same reference numerals, and the detailed description is neglected.

In the apparatus of the fifteenth embodiment, the electrode unit is provided in the lower chamber of the treatment water tank 1. The electrode unit includes the plurality of first electrodes 4 and the plate-shaped second electrode 3. The second electrode 3 constitutes the ground electrode, and is arranged in the treatment water 2. The second electrode 3 is formed by the electrode member having the metal mesh structure, and the second electrode 3 is arranged in parallel with the first electrode 4. The electrode unit is attached to the bottom portion of the treatment water tank 1 made of, for example, stainless steel through the insulating portion 6.

The first electrode 4 includes the electrode member having the hollow cylindrical structure, to which the high voltage necessary to the electric discharge is applied from the power supply 5, and the first electrode 4 has the gas flow path 41 formed by the hollow portion. In the first electrode 4, the periphery of the electrode member is covered with the dielectric member 11 made of, for example, quartz glass. The electric discharge portion 40 located at the leading edge of each first electrode 4 is arranged in the treatment water 2.

In the apparatus of the fifteenth embodiment, the lower chamber of the treatment water tank 1 in which the electrode unit is provided has the same structure as the gas tank 9 in which the gas inflow pipe 7 is provided.

The functional effect of the fifteenth embodiment will be described below.

The gas 70 such as air containing moisture is caused to flow in the lower chamber of the treatment water tank 1 through the gas inflow pipe 7. According to the inflow pressure, the gas 70 passes through the gas flow paths 41 provided in the first electrode 4, and the gas 70 is blown into the treatment water 2 from the mesh of the second electrode 3, which allows the gas space to be formed at the leading edge of the first electrode 4 (electric discharge portion 40) opposite to the second electrode 3, and the leading edge is not in direct contact with the treatment water 2.

In this state, when the high voltage is applied to the electrode unit from the power supply 5, the electric discharge is generated from the electric discharge portion 40 that is of the leading edge of the first electrode 4. Accordingly, at the leading edge of the first electrode 4, the radical is generated by the electric discharge from the gas 70 flowing in the gas flow paths 41 from the gas inflow pipe 7. Both the radical and the gas 70 are blown into the treatment water 2 from the mesh of the second electrode 3 so as to impinge on the water. Therefore, the bubbles 10 are generated near the mesh by the gas 70.

Thus, according to the fifteenth embodiment, the leading edge of the first electrode 4 which is of the electric discharge portion 40 is in the same state as the state in which the leading edge is arranged in the treatment water 2, so that the radical can efficiently be dissolved into the treatment water 2. Accordingly, the radical can efficiently decompose the recalcitrant organic matter dissolved in the water.

(Sixteenth Embodiment)

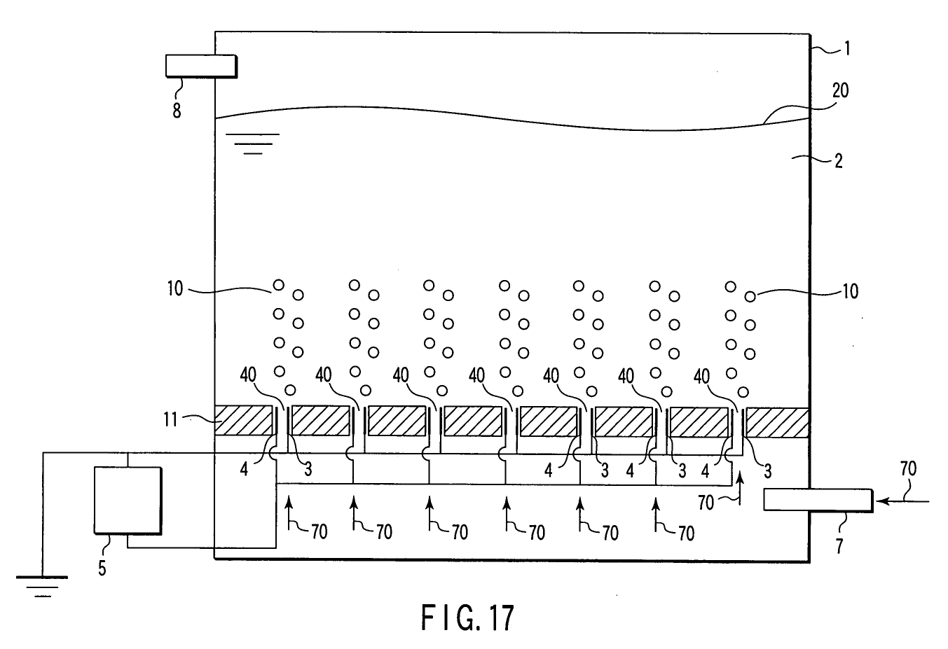

FIG. 17 is a diagram showing a configuration of a water treatment apparatus according to a sixteenth embodiment of the invention. In the sixteenth embodiment, the same configuration as the apparatus shown in FIGS. 1 and 8 is indicated by the same reference numerals, and the detailed description is neglected.

In the apparatus of the sixteenth embodiment, the electrode unit is provided in the lower chamber of the treatment water tank 1. The electrode unit includes the dielectric member 11 made of the quartz glass, the first electrode 4, and the second electrode 3. The electrode unit has the structure in which the first electrode 4 and the second electrode 3 are oppositely arranged in the prism hollow portion (through-hole) 40 provided in the dielectric member 11.

As mentioned later, the hollow portion 40 forms the gas flow path. The gas 70 flows in through the gas flow path, and is blown into the treatment water 2 through the gas flow path. The first electrode 4 is one to which the high voltage is applied from the power supply 5. The second electrode 3 is the ground electrode. The hollow portion 40, in which the first and second electrodes 4 and 3 are arranged, corresponds to the electric discharge portion which discharges in the gas space. The gas space is formed in the hollow portion 40, and the hollow portion 40 is not in direct contact with the treatment water 2.

In the apparatus of the sixteenth embodiment, the lower chamber of the treatment water tank 1 in which the electrode unit is provided has the same structure as the gas tank 9 in which the gas inflow pipe 7 is provided.

The functional effect of the sixteenth embodiment will be described below.

The gas 70 such as air containing moisture is caused to flow in the lower chamber of the treatment water tank 1 through the gas inflow pipe 7. According to the inflow pressure, the gas 70 flows in from the hollow portion 40 of the electrode unit, and the gas 70 is blown into the treatment water 2 so as to impinge on the treatment water 2, which allows the gas space to be formed in the hollow portion 40.

In this state, when the high voltage is applied to the first electrode 4 from the power supply 5, the electric discharge is generated in the hollow portion 40. Accordingly, in the hollow portion 40, the radical is generated by the electric discharge from the gas 70 flowing in from the gas inflow pipe 7. Both the radical and the gas 70 are blown into the treatment water 2. Therefore, the bubbles 10 are generated by the gas 70 in the hollow portion 40.

Thus, according to the sixteenth embodiment, the electric discharge portion which is of the hollow portion 40 is in the same state as the state in which the electric discharge portion is arranged in the treatment water 2, so that the radical can efficiently be dissolved into the treatment water 2. Accordingly, the recalcitrant organic matter dissolved in the water can efficiently be decomposed by the radical.

(Seventeenth Embodiment)

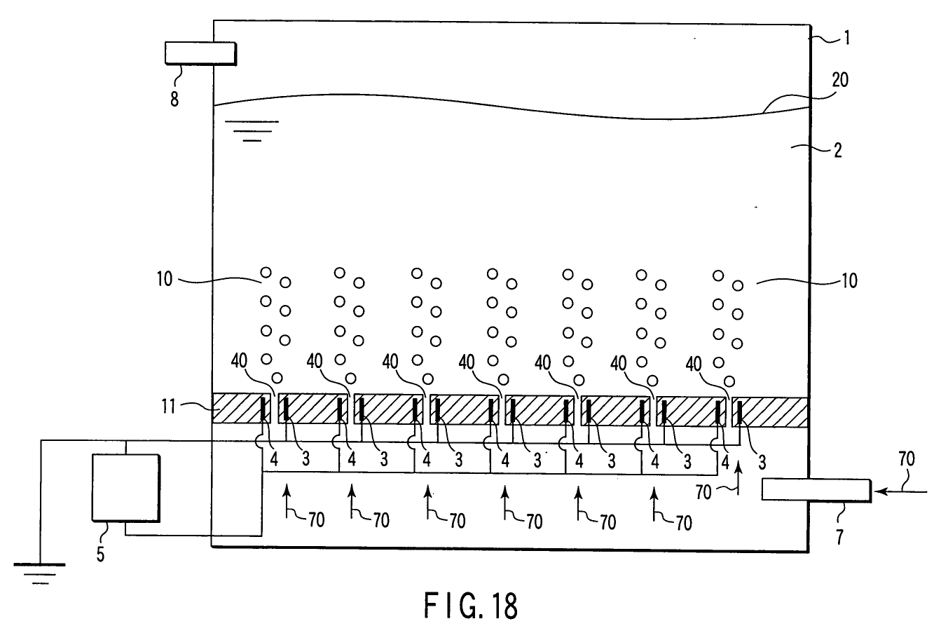

FIG. 18 is a diagram showing a configuration of a water treatment apparatus according to a seventeenth embodiment of the invention. In the seventeenth embodiment, the same configuration as the apparatus shown in FIGS. 1 and 17 is indicated by the same reference numerals, and the detailed description is neglected.

In the apparatus of the seventeenth embodiment, the electrode unit is provided in the lower chamber of the treatment water tank 1. The electrode unit includes the dielectric member 11 made of the quartz glass or the like, the first electrode 4, and the second electrode 3. The electrode unit has the prism hollow portion (through-hole) 40 provided in the dielectric member 11. As mentioned later, the hollow portion 40 forms the gas flow path. The gas 70 flows in through the gas flow path, and is blown into the treatment water 2 through the gas flow path.

The first electrode 4 is one to which the high voltage is applied from the power supply 5. The second electrode 3 is the ground electrode. The first and second electrodes 4 and 3 are incorporated into the dielectric member 11, and the first and second electrodes 4 and 3 are arranged so as to oppose to each other through the hollow portion 40. Therefore, the hollow portion 40 functions as the electric discharge portion which discharges in the gas space. The gas space is formed in the hollow portion 40, and the hollow portion 40 is not in direct contact with the treatment water 2.

In the apparatus of the seventeenth embodiment, the lower chamber of the treatment water tank 1 in which the electrode unit is provided has the same structure as the gas tank 9 in which the gas inflow pipe 7 is provided.

The functional effect of the sixteenth embodiment will be described below.

The gas 70 such as air containing moisture is caused to flow in the lower chamber of the treatment water tank 1 through the gas inflow pipe 7. According to the inflow pressure, the gas 70 flows in from the hollow portion 40 of the electrode unit, and the gas 70 is blown into the treatment water 2 so as to impinge on the treatment water 2, which allows the gas space to be formed in the hollow portion 40.

In this state, when the high voltage is applied to the first electrode 4 from the power supply 5, the electric discharge is generated in the hollow portion 40. The electric discharge is generated as numerous micro-discharges in the gas space of the hollow portion 40.

Accordingly, in the hollow portion 40, the radical is generated by the electric discharge from the gas 70 flowing in from the gas inflow pipe 7. Both the radical and the gas 70 are blown into the treatment water 2. Therefore, the bubbles 10 are generated by the gas 70 in the hollow portion 40.

Thus, according to the seventeenth embodiment, the electric discharge portion that is of the hollow portion 40 is in the same state as the state in which the electric discharge portion is arranged in the treatment water 2, so that the radical such as the OH radical can efficiently be dissolved into the treatment water 2. Accordingly, the radical can efficiently decompose the recalcitrant organic matter dissolved in the water.

(Eighteenth Embodiment)

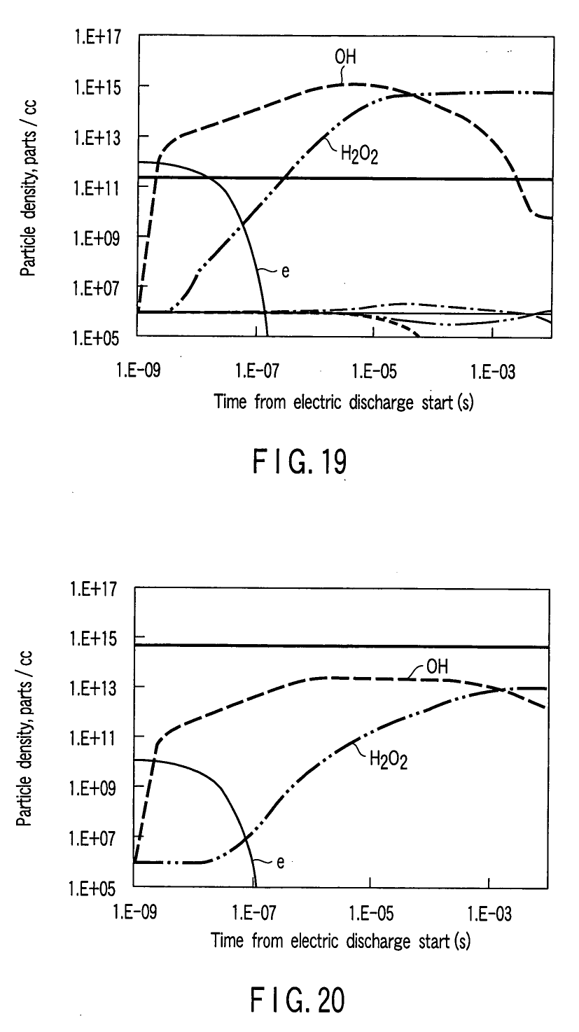

FIGS. 19 to 21 are graphs for explaining the functional effect of the water treatment apparatus according to an eighteenth embodiment. In the same configuration as the water treatment apparatus according to the first embodiment shown in FIGS. 1 and 2, the eighteenth embodiment relates to means for controlling the electric discharge generated between the electrodes according to the high-voltage pulse provided from the power supply 5. Specifically, the means (not shown) includes a computer and a power supply control device, which control the high-voltage pulse provided from the power supply 5.

Referring to FIGS. 19 to 21, the functional effect of the eighteenth embodiment will be described. In FIGS. 19 and 20, “1.E±n” means a power of 10 while “n” is an exponent. For example, “1.E−6s” expresses 10 μs. This notation has the same meanings in the following embodiments.

It is confirmed that a life of the OH radical generated in the gas phase is determined by density of the OH radical. An extinction reaction formula (13) of the OH radical is shown below.
OH+OH→H₂O₂ (13)

A reaction rate of the extinction reaction formula (13) can be expressed by the following chemical formula (14) using a rate constant k and OH radical density [OH].

$$\begin{matrix}ⅆ [ OH ] / ⅆ t = - k * [ OH ] * [ OH ] - k * [ OH ] * [ OH ] \\ = - 2 * k * [ OH ] * [ OH ]\end{matrix} \qquad ( 14 )$$

As can be seen from the chemical formula (14), the OH radical is decreased in the density in proportion to the square of concentration of the OH radical. Namely, as the density of the OH radical is increased, the extinction rate of the OH radical is increased, and the life of the OH radical becomes shortened.

FIG. 19 shows the result of a reaction simulation of a dielectric barrier discharge.

As shown in FIG. 19, the density of the OH radical reaches a peak value at about 10 μs after the electric discharge is generated, and then the density is rapidly decreased. Assuming that the life of the OH radical is one-tenth of the peak value, the life is about 100 μs. In FIG. 19, “e” indicates electron density. As discharge energy is increased, the electron density is increased.

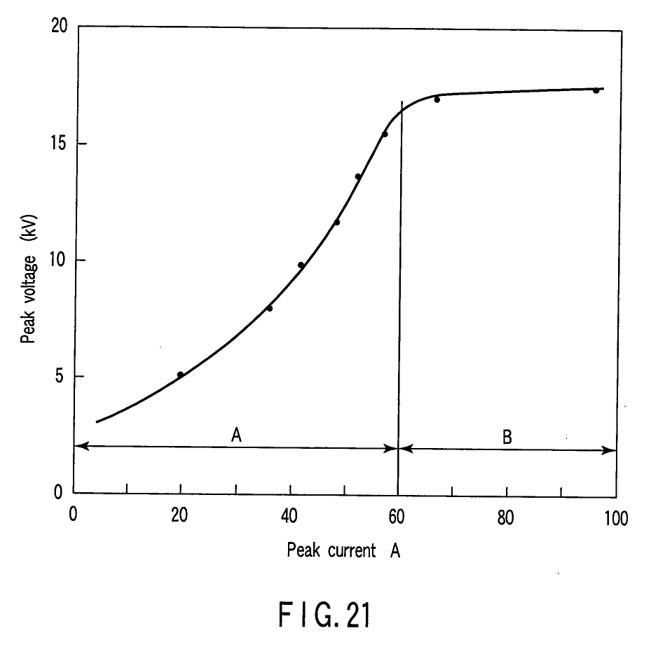

FIG. 20 shows the result of the reaction simulation of the corona discharge according to the eighteenth embodiment. As described later referring to FIG. 21, the eighteenth embodiment has the configuration in which the electric discharge control is performed so as to have an electric discharge characteristic corresponding to the corona discharge.

As shown in FIG. 20, in the electric discharge characteristic, the density of the OH radical reaches the peak value at about 10 μs after the electric discharge is generated, and then the decrease in density is small. The life of the OH radical is about 10 ms.

The difference between the dielectric barrier discharge and the corona discharge is the amount of generation of the OH radical. In the dielectric barrier discharge, the density of the OH radical is 10¹⁵/cm³ at the peak (see FIG. 19). On the other hand, in the corona discharge of the embodiment, the density of the OH radical is 10¹⁴/cm³ at the peak (see FIG. 20).

In the apparatus of the eighteenth embodiment, it is assumed that a distance between the leading edge of the pin electrode and the water surface of the treatment water ranges from zero to tens of mm. Accordingly, when the life of the OH radical is about 10 ms, the OH radical generated by the electric discharge can sufficiently reach the treatment water by concentration diffusion, ionic wind, and gas flow. As a result, in the case where the density of the OH radical is 10¹⁴/cm³, the water treatment can efficiently be performed by the OH radical.

Further, referring to FIG. 21, the electric discharge characteristic of the corona discharge in the embodiment will be described.

The corona discharge is generated by the locally high electric field. When the locally high electric field reaches dielectric breakdown strength of the atmospheric gas, the corona discharge is formed. As shown in FIG. 21, in a voltage-current characteristic of the corona discharge, the voltage is increased as the current is increased. Assuming that an increasing rate of the current is dI and an increasing rate of the voltage is dV, a ratio of “dV/dI” is increased as the current is increased.

However, when the voltage exceeds a certain value, the current value is rapidly increased (in this case, an inflection point is located around 60 A). Namely, the ratio of “dV/dI” is decreased. This is because the electron density in the electric discharge is rapidly increased and the electric discharge power becomes also high (electric discharge power region B shown in FIG. 21).

In such the case, the life of the OH radical is remarkably shortened while the amount of generation of the OH radical is increased (see FIG. 19). Therefore, in the eighteenth embodiment, the electric discharge is controlled so that the water treatment is performed in the electric discharge state in which the ratio of “dV/dI” is increased as the current is increased (electric discharge power region B shown in FIG. 21). Namely, in the eighteenth embodiment, the OH radical whose life is relatively longer is generated by the corona discharge to perform the water treatment at high efficiency.

(Nineteenth Embodiment)

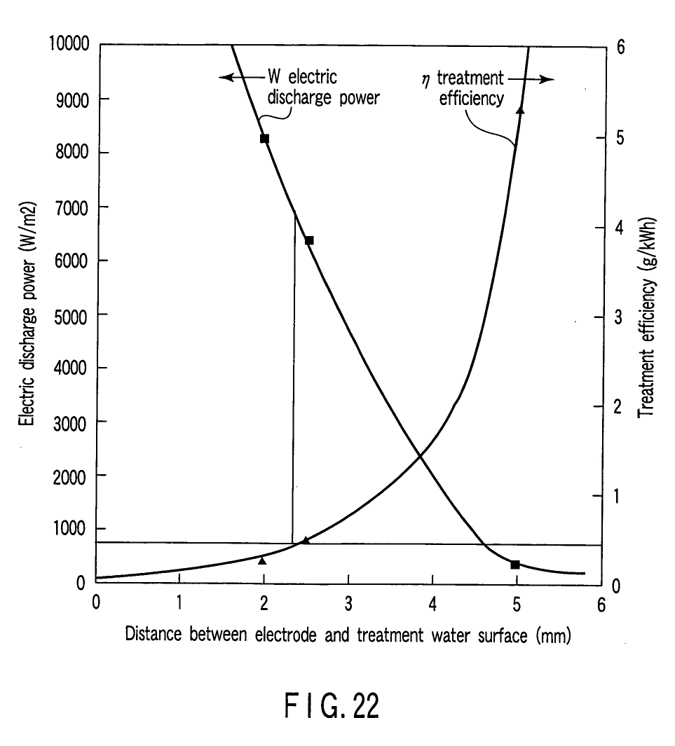

FIG. 22 is a graph for explaining the functional effect of a water treatment apparatus according to a nineteenth embodiment of the invention. In the same configuration as the water treatment apparatus according to the first embodiment shown in FIGS. 1 and 2, the nineteenth embodiment relates to means for controlling the electric discharge generated between the electrodes according to the high-voltage pulse provided from the power supply 5. Specifically, the means (not shown) includes a computer and a power supply control device, which control the high-voltage pulse provided from the power supply 5.

FIG. 22 shows characteristics of the distance between the electrode and the treatment water surface, electric discharge power (W), and treatment efficiency (η) in the case where it is assumed that the treatment water 2 is acetic acid. The applied voltage is fixed at 10 kV.

Attention is directed toward the case in which the distance between the electrode and the treatment water surface is about 2.5 mm (position shown by thin line). When the electric discharge power per surface area 1 m² of the treatment water is lowered below 7 kW, it is confirmed that the treatment efficiency (η) is increased. Specifically, because it is estimated that the treatment efficiency (η) of acetic acid is about 0.5 g/kWh in an ozone/ultraviolet ray method that is of the conventional OH radical generation method, the treatment efficiency (η) can relatively be improved.

Namely, in the nineteenth embodiment, the electric discharge control is performed so that the upper limit of the electric discharge power per surface area 1 m² of the treatment water becomes about 7 kW, which allows the high treatment efficiency to be realized. When the electric discharge power is relatively decreased, the concentration of the OH radical is decreased. Therefore, it is presumed that the life of the OH radical is relatively lengthened. Accordingly, it is presumed that the OH radical exists for a relatively longer time and the OH radical affects the treatment of acetic acid that is of the treatment water.

(Twentieth Embodiment)

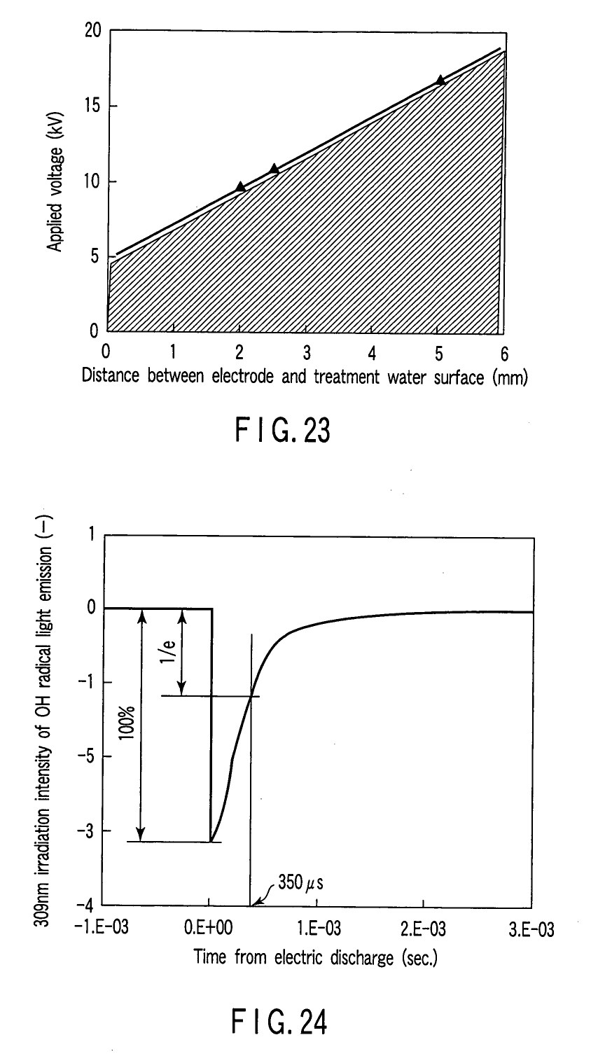

FIG. 23 is a graph for explaining the functional effect of a water treatment apparatus according to a twentieth embodiment of the invention. In the same configuration as the water treatment apparatus according to the first embodiment shown in FIGS. 1 and 2, the twentieth embodiment relates to means for controlling the electric discharge generated between the electrodes according to the high-voltage pulse provided from the power supply 5. Specifically, the means (not shown) includes a computer and a power supply control device, which control the high-voltage pulse provided from the power supply 5.

FIG. 23 shows a relationship between the distance between the electrode and the treatment water surface and the applied voltage in the case where the treatment efficiency (the treatment water is acetic acid) shown in FIG. 22 is not lower than 0.5 g/kWh. In the condition of a part shown by oblique lines, the treatment efficiency is relatively increased. In other parts, the treatment efficiency is relatively decreased. Namely, in the case where the distance between the electrode and the treatment water surface is about 2.5 mm, when the applied voltage is the electric discharge power of about 10 kV (about 7 kW as shown in FIG. 22), the relatively high treatment efficiency (η) is shown.

When the positive pulse voltage is applied as the high-voltage pulse, the conditional expression of “V<2.4×d+5, and d>0” satisfies the part shown by oblique lines of FIG. 23, where d (mm) is the distance between the electrode and the treatment water surface and V (kV) is the applied voltage from the high-voltage pulse power supply 5. When the negative pulse voltage is applied as the high-voltage pulse from the high-voltage pulse power supply 5, the conditional expression of “V<−2.4×d−5, and d>0” satisfies the part shown by oblique lines of FIG. 23.

Namely, in the twentieth embodiment, the provision of the high-voltage pulse is controlled so that the conditional expression is satisfied, which allows the high treatment efficiency to be realized.

(Twenty-First Embodiment)

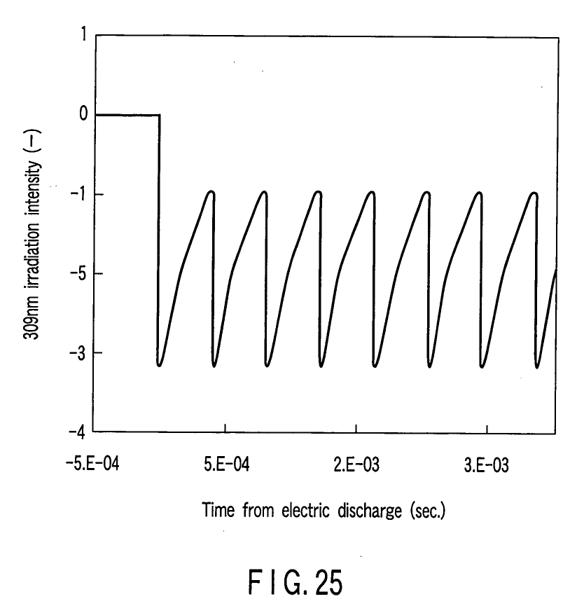

FIGS. 24 and 25 are graphs for explaining the functional effect of a water treatment apparatus according to a twenty-first embodiment of the invention. In the same configuration as the water treatment apparatus according to the first embodiment shown in FIGS. 1 and 2, the twenty-first embodiment relates to means for controlling the electric discharge generated between the electrodes according to the high-voltage pulse provided from the power supply 5. Specifically, the means (not shown) includes a computer and a power supply control device, which control the high-voltage pulse provided from the power supply 5.

FIG. 24 shows a time change of the ultraviolet ray (wavelength is 309 nm), which is emitted when the OH radical returns to a ground state (X²Π) from an excited state (A²Σ), since the electric discharge is started. In FIG. 24, “e” means the natural logarithm. 350 μs expresses the time when the concentration of the OH radical is decreased from the peak value to 1/e.

Light having the wavelength of 309 nm means the density of the OH radical in the excited state (A²Σ). FIG. 24 shows that the concentration of the OH radical is increased toward the negative direction. Since the light emission is generated in the transition of the OH radical from the excited state to the ground state, it can be said that the OH radical in the ground state is higher than the OH radical in the excited state in the density.

As shown in FIG. 24, the life of the Oh radical in the excited state is about 350 μs since the electric discharge is started. When the electric discharge is repeatedly generated at an interval longer than 350 μs, the OH radical repeats the generation and the extinction in the gas phase. However, when the electric discharge is repeatedly generated at an interval shorter than 350 μs, since the OH radical is generated again by the electric discharge before all the generated OH radicals are extinguished, the density of the OH radical continues to increase.

When the density of the OH radical continues to increase, the extinction by the reaction between the OH radicals is generated, which results in the decrease in treatment efficiency. Therefore, in the twenty-first embodiment, as shown in FIG. 25, the electric discharge control is performed so that a repetition frequency of the high-voltage pulse for the electric discharge is set in the range not more than 3 kHz (frequency corresponding to the time of 350 μs when the concentration of the OH radical is lowered from the peak value to 1/e), which allows the water treatment to be performed at high efficiency.

(Twenty-Second Embodiment)

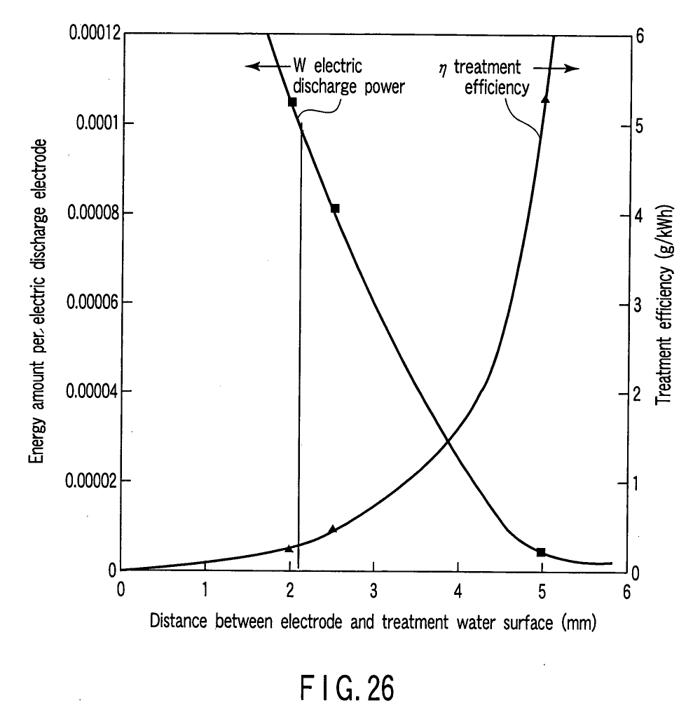

FIG. 26 is a graph for explaining the functional effect of a water treatment apparatus according to a twenty-second embodiment of the invention. In the same configuration as the water treatment apparatus according to the first embodiment shown in FIGS. 1 and 2, the twenty-second embodiment relates to means for controlling the electric discharge generated between the electrodes according to the high-voltage pulse provided from the power supply 5. Specifically, the means (not shown) includes a computer and a power supply control device, which control the high-voltage pulse provided from the power supply 5.

FIG. 26 shows the characteristics of the distance between the electrode and the water surface of the treatment water (in this case, acetic acid), the amount of electric discharge power per one pin electrode 4, and the treatment efficiency (η) in the plurality of pin electrodes 4.

Attention is directed toward the case in which the distance between the electrode and the treatment water surface is about 2.5 mm (position shown by the thin line). When the amount of electric discharge power per one pin electrode is lowered below 100 μWs, it is confirmed that the treatment efficiency (η) is increased. Specifically, because it is estimated that the treatment efficiency (η) of acetic acid is about 0.5 g/kWh in the ozone/ultraviolet ray method that is of the conventional OH radical generation method, the treatment efficiency (η) can relatively be improved.

Namely, in the twenty-second embodiment, the electric discharge control is performed so that the upper limit of the amount of electric discharge power per one pine electrode becomes about 100 μWs, which allows the high treatment efficiency to be realized. When the amount of electric discharge power is relatively decreased, the concentration of the OH radical is decreased. Therefore, it is presumed that the life of the OH radical is relatively lengthened. Accordingly, it is presumed that the OH radical exists in the valid state for a relatively longer time and the OH radical affects the treatment of acetic acid which is of the treatment water.

The twenty-second embodiment can also be applied to the wire electric discharge using the wire electrode in the apparatus corresponding to the eighth embodiment described referring to FIG. 9. In this case, the electric discharge control is performed so that the upper limit of the amount of electric discharge power per wire electrode of 1 m becomes about 100 mWs, which allows the high treatment efficiency to be realized.

(Twenty-Third Embodiment)

In the same configuration as the water treatment apparatus according to the first embodiment shown in FIGS. 1 and 2, a twenty-third embodiment of the invention relates to means for controlling the electric discharge generated between the electrodes according to the high-voltage pulse provided from the power supply 5. Specifically, the means (not shown) includes a computer and a power supply control device, which control the high-voltage pulse provided from the power supply 5.

In the twenty-third embodiment, the provision of the high-voltage pulse is controlled so that the average current passing through per 1 m² of the treatment water becomes not more than 30 A when the electric discharge is generated by applying the high voltage to the electrode from the power supply.

Specifically, the electric discharge power region A can be realized when the ground electrode is not more than 30 A/m².

(Twenty-Fourth Embodiment)

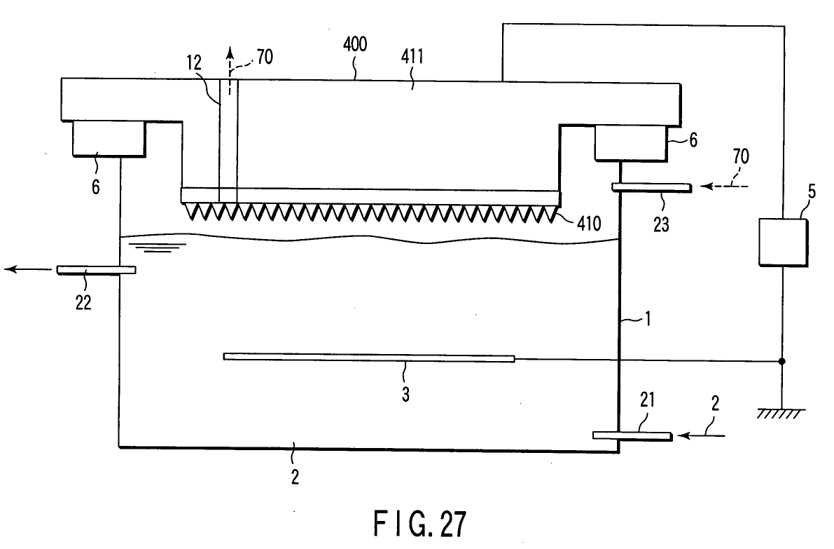

FIG. 27 is a diagram for explaining a configuration of a radical treatment apparatus according to a twenty-fourth embodiment of the invention.

As shown in FIG. 27, the apparatus has a structure in which a first electrode member 400 of the electrode unit is attached to the water tank 1 through the insulating flange 6. The water 2 (hereinafter referred to as treatment water) is stored in the water tank 1. The treatment water 2 is the water containing the recalcitrant organic matter such as dioxin.

Inflow ports 21 in which the treatment water 2 flows and an outflow port 22 from which the treatment water 2 is drained are provided in the water tank 1. The water 2 is continuously treated as it flows in the water tank 1 from the inflow port 21 to the outflow port 22. Nonetheless, the water 2 may be treated in the tank 1 in any other manner. In this case, the water tank 1 need not have the ports 21 and 22. A gas introduction port 23 that introduces the gas 70 containing the air or oxygen is also provided in the water tank 1.

The first electrode member 400 has a structure in which a plurality of projection members 410 for generating the electric discharge is provided on a main body 411. A gas exhaust port 12, which exhausts a part of the gas 70 introduced from the gas introduction port 23, is provided in the first electrode member 400.

The radical treatment apparatus has the high-voltage power supply 5 that applies the high voltage between the main body 411 of the first electrode member 400 and the second electrode member (ground electrode) 3 arranged in the water tank 1. In the first electrode member 400, according to the application of the high voltage, the electric discharge is generated from the leading edge of each projection member 410. The ground electrode 3 is formed by a disk-shaped metal plate.

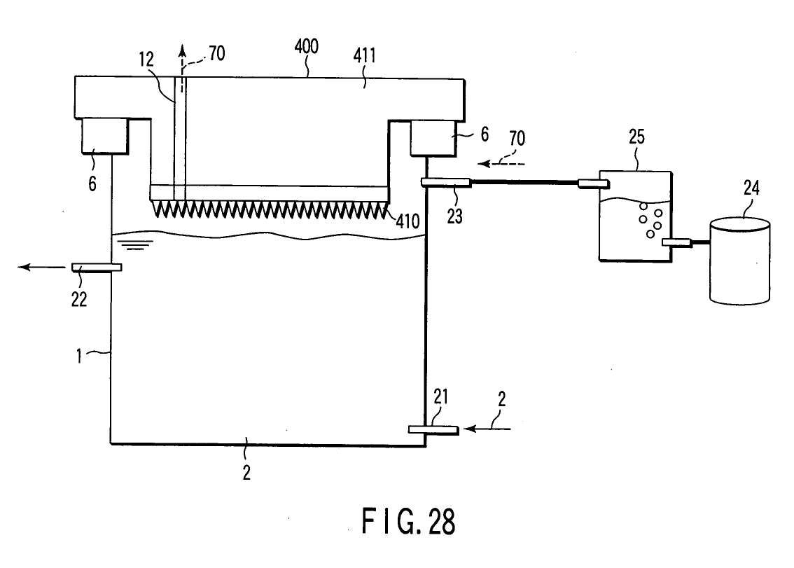

The gas 70 is supplied from a gas supply device 24 shown in FIG. 28. The gas supply device 24 includes an air compressor or an air cylinder that supplies the air. Alternatively, the gas supply device 24 includes an oxygen cylinder that supplies the air or an oxygen production device (PSA) that produces oxygen.

It is preferable that the gas 70 is introduced from the gas supply device 24 to the gas introduction port 23 through a water tank 25. The water tank 25 is one in which the water used for causing air or oxygen to contain the moisture is stored. It is confirmed that the gas 70 containing the water molecule is the gas that is easy to generate the OH radical by the later-mentioned electric discharge.

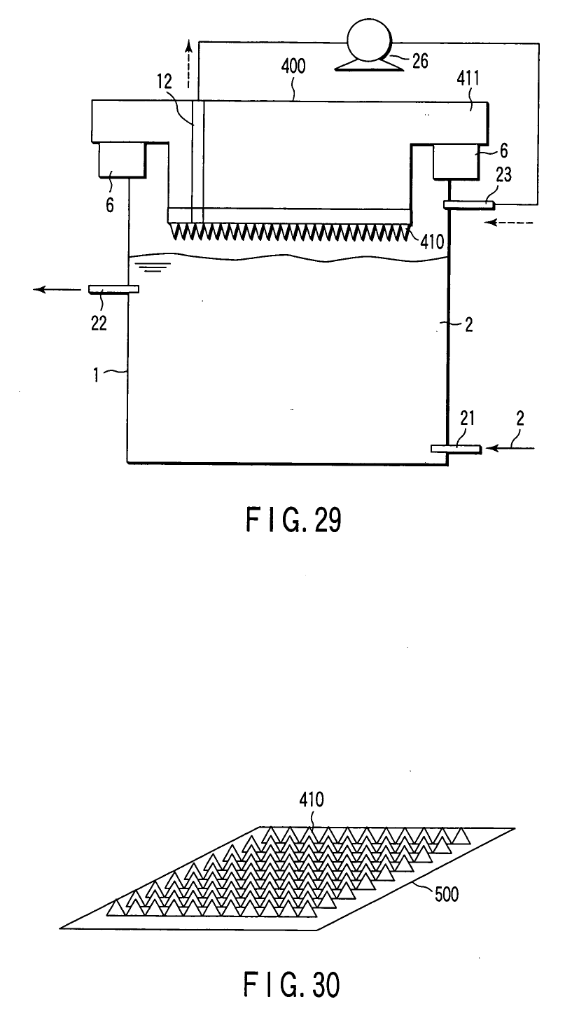

As shown in FIG. 29, the radical treatment apparatus has a pump 26 that delivers the gas 70, which is exhausted from the gas exhaust port 12, to the gas introduction port 23. Accordingly, the gas 70 can efficiently be used.

(Structure of Electrode)

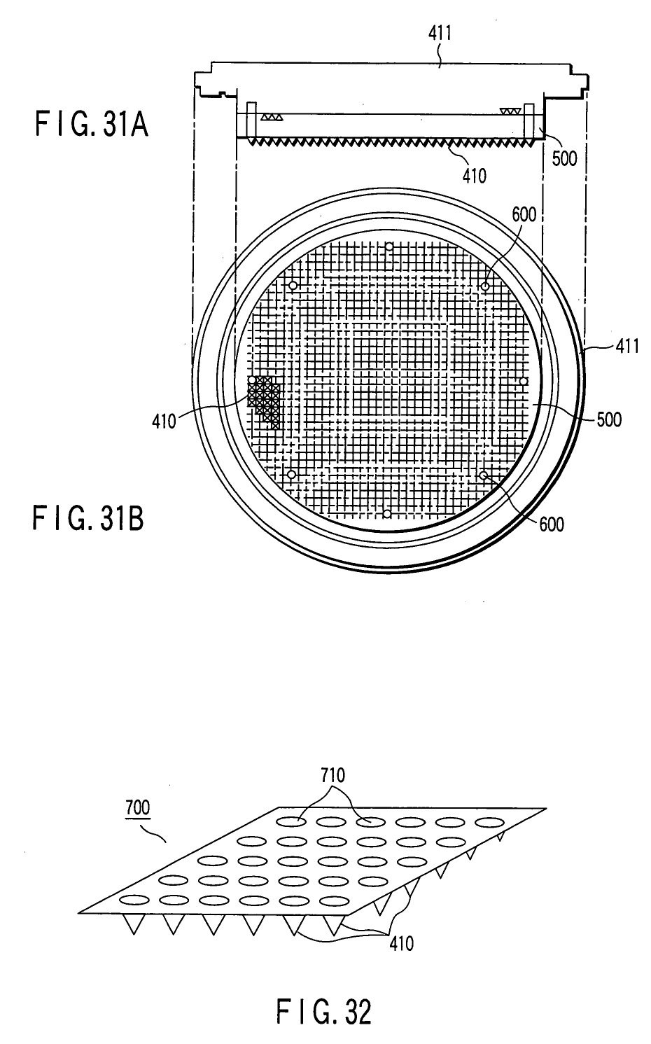

FIGS. 30, 31A, and 31B show the structure of the first electrode 400 of the twenty-fourth embodiment.

The first electrode 400 has the plurality of projection members 410 which is formed by cutting one metal plate 500. Each projection member 410 is configured in a pyramid shape so that the leading edge where the electric discharge is generated becomes an acute angle. It is also possible that each projection member 410 is configured in a conical shape or the needle shape.

FIGS. 31A and 31B show the specific structure of the first electrode 400. FIG. 31A is a side view, and FIG. 31B is a plan view. As shown in FIG. 31A, the first electrode 400 has a structure in which the metal main body 411 is joined to one metal plate 500 on which the plurality of projection members 410 are formed by the cutting. Specifically, as shown in FIG. 31B, the first electrode 400 has a structure in which the one disk-shaped metal plate 500 on which the projection members 410 are formed is fixed to the plane of the disk-shaped main body 411 with screws 600.

It is preferable that the projection member 410 is made of corrosion resistant metal. When the electric discharge is generated near the water surface of the treatment water 2, corrosion of the projection member 410 is easy to occur by vapor from the treatment water 2. Therefore, when the projection member 410 is made of corrosion resistant metal, the corrosion can be suppressed to lengthen a component life. Accordingly, running costs can be reduced. Specifically examples of the corrosion resistant metal include the stainless steel.

(Function and Effect)

Referring to FIG. 27, the function and effect of the radical treatment apparatus according to the twenty-fourth embodiment will be described below.

The treatment water 2 flows into the water tank 1 from the inflow port 21. Then, the gas 70 that is of, e.g. the air is introduced from the gas introduction port 23. The gas 70 is supplied so that the periphery of each projection member 410 of the first electrode 400 is filled with the gas 70.

In the atmosphere of the filled gas 70, when the high voltage is applied from the power supply 5 between the main body 411 of the first electrode 400 and the ground electrode 3 arranged in the water tank 1, the electric discharge is generated from the leading edge of each projection member 410.

The electric discharge is generated between the leading edge of each projection member 410 and the water surface of the treatment water 2 in the atmosphere of the gas 70. A mode of the electric discharge is changed according to a level of the applied voltage from the high-voltage power supply 5. When the applied voltage remains at a relatively low level, the electric discharge becomes the corona discharge that is generated near the leading edge of each projection member 410. When the applied voltage reaches a relatively high level, the electric discharge becomes a streamer discharge that is generated across the water surface of the treatment water 2 from the leading edge of each projection member 410.

As described above, in the case where the corona discharge having the low electric power necessary to the electric discharge is generated by the applied voltage of the relatively low level, it is confirmed that the density of the OH radical becomes low and the life of the OH radical is lengthened. Accordingly, in the radical treatment apparatus, the corona discharge is generated from each projection member 410 of the first electrode 400 by applying the low-level applied voltage from the high-voltage power supply 5. The Oh radical and ozone (O₃) are generated by the corona discharge to decompose the organic matter contained in the treatment water 2. A reaction process of the organic decomposition by the electric discharge will be described below.

The corona discharge generated from each projection member 410 of the first electrode 400 reacts with the water molecule (H₂O) generated by saturated vapor pressure of the treatment water 2 and oxygen (O₂) in the gas 70. Specifically, in the corona discharge, the OH radical (OH), the oxygen atom O(³P) in the ground state, and the oxygen atom O(¹D) in the excited state are generated by the collision between the electron e and the gas molecule.

The reaction process is shown by the following chemical formulas (21) to (31):
e+H₂O→.OH+H+e (21)
e+O₂→O(¹D)+O(³P) (22)

At this point, O(¹D) reacts with the water molecule to generate the OH radical as shown in the following chemical formula (23):
O(¹D)+H₂O→2.OH (23)

The OH radical forms hydrogen peroxide by recombination of the OH radicals as shown in the following chemical formula (24):
.OH+.OH→H₂O₂ (24)

When hydrogen peroxide is dissolved in the water, hydrogen peroxide is dissociated to form HO₂⁻ and the hydrogen ion H⁺ as shown in the following chemical formula (25):
H₂O₂ [symbol] HO₂⁻+H⁺ (25)

At this point, the generated HO₂⁻ reacts with O₃ to form O₃⁻ and the HO₂ radical as shown in the following chemical formula (26):
HO₂⁻+O₃→O₃⁻+HO₂. (26)

At this point, the generated HO₂. is dissociated to form O₂⁻ and H⁺ as shown in the following chemical formula (27):
HO₂. [symbol] O₂⁻+H⁺ (27)

At this point, the generated O₂⁻ reacts with ozone to form O₃⁻ as shown in the following chemical formula (28):
O₂⁻+O₃→O₃⁻+O₂ (28)

O₃⁻ reacts with H⁺ to form HO₃ as shown in the following chemical formula (29):
O₃⁻+H⁺→HO₃ (29)

HO₃ is dissociated to form the OH radical as shown in the following chemical formula (30):
HO₃+→.OH+O₂ (30)

Thus, HO₂⁻ dissociated from hydrogen peroxide H₂O₂ reacts with ozone to generate the HO₂ radical, and the OH radical is formed in the water to react with an organic matter R contained in the treatment water 2. At this point, as shown in the following chemical formula (31), the OH radical resolves the organic matter R into the water, carbon dioxide gas, and hydrogen peroxide.
.OH+R→H₂O+CO₂+H₂O₂ (31)

Namely, the recalcitrant organic matter (R) dissolved in the treatment water 2 is decomposed and treated by the corona discharge which reacts with the gas 70.

As described above, according to the radical treatment apparatus of the twenty-fourth embodiment, the corona discharge is generated from each projection member 410 of the first electrode 400 by applying the low-level applied voltage from the high-voltage power supply 5. The OH radical and ozone (O₃) are generated by the corona discharge to decompose the organic matter contained in the treatment water 2. In this case of the corona discharge in which the applied voltage is at the relatively low level and the electric power necessary to the electric discharge is low, the density of the OH radical becomes low and the life of the OH radical becomes lengthened, so that the high treatment efficiency can be realized.

In the first electrode 400 of the twenty-fourth embodiment, each pyramid-shaped projection member 410 is formed by cutting the one metal plate 500 so that the leading edge of each projection portion where the electric discharge is generated becomes an acute angle. Accordingly, because the electric discharge electrode where the corona discharge is generated can be produced at relatively low cost, the practical radical treatment apparatus can easily be provided.

(Twenty-Fifth Embodiment)

FIG. 32 is a view showing a structure of a first electrode 400 according to a twenty-fifth embodiment of the invention. Because the configuration of the radical treatment apparatus is similar to the configuration shown in FIGS. 27 to 29, the description is neglected.

The first electrode 400 of the twenty-fifth embodiment has the plurality of projection members 410 which are formed by press working of one metal plate 700. Each projection member 410 is formed in the pyramid shape so that the leading edge where the electric discharge is generated becomes an acute angle. In each projection member 410, concave portions 710 punched by the press working are formed in the surface that is connected to the side of the main body 411.

In the structure of the first electrode 400 according to the twenty-fifth embodiment, as with the twenty-fourth embodiment, because the electric discharge electrode where the corona discharge is generated can also be produced at relatively low cost, the practical radical treatment apparatus can easily be provided.

(Twenty-Sixth Embodiment)

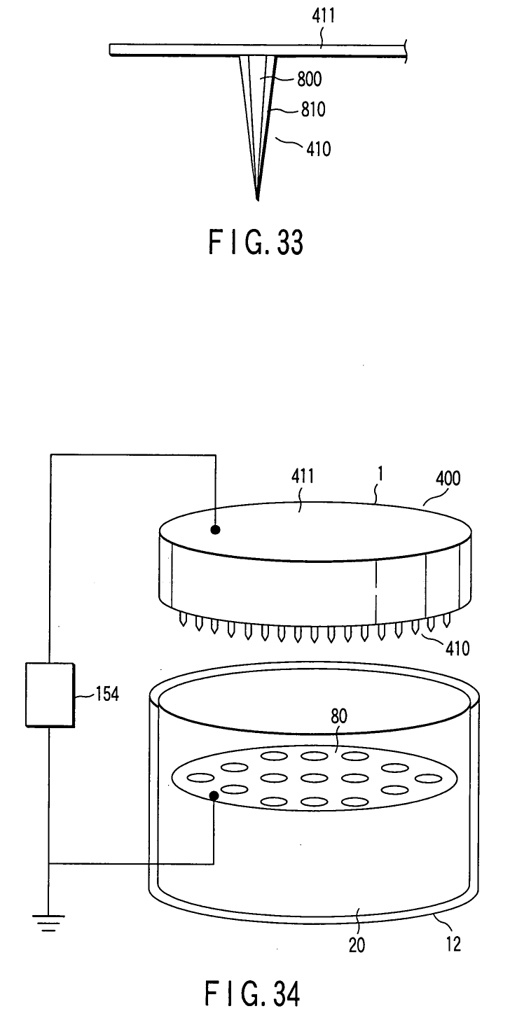

FIG. 33 is a view showing a structure of a first electrode 400 according to a twenty-sixth embodiment of the invention. Because the configuration of the radical treatment apparatus is similar to the configuration shown in FIGS. 27 to 29, the description is neglected.

The first electrode 400 of the twenty-sixth embodiment has the plurality of projection members 410 having two-layer structures. Each projection member 410 includes a metal projection portion 800 and a dielectric body 810, and the periphery of the projection portion 800 is covered with the dielectric body 810. Each projection member 410 is formed in the conical shape or the pyramid shape so that the leading edge where the electric discharge is generated becomes an acute angle.

According to the first electrode 400 having the structure of the twenty-sixth embodiment, the corona discharge can stably and evenly be generated from each projection member 410 toward the water surface of the treatment water 2 by ballast effect of the dielectric body 810. As with the first embodiment, because the electric discharge electrode where the corona discharge is generated can be produced at relatively low cost, the practical radical treatment apparatus can easily be provided.

(Twenty-Seventh Embodiment)

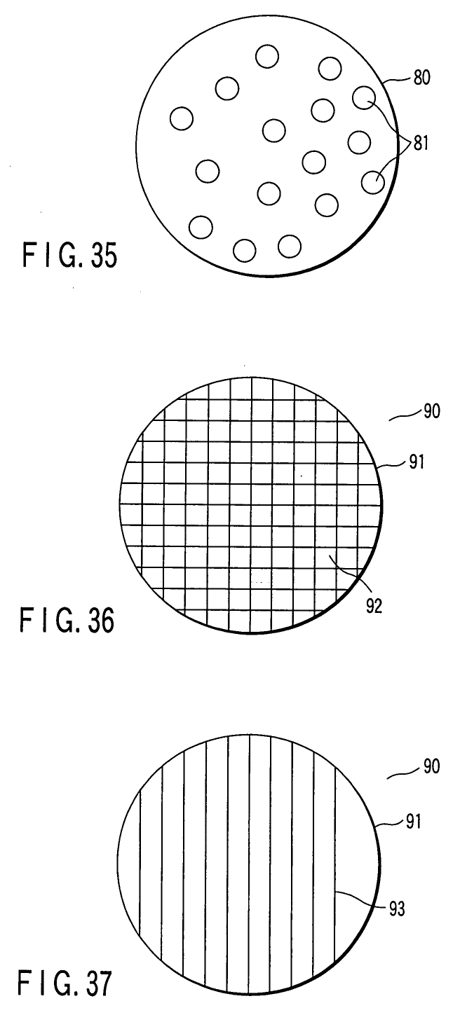

FIGS. 34 and 35 are diagrams for explaining a configuration of a radical treatment apparatus according to a twenty-seventh embodiment of the invention. FIG. 35 is a plan view. In the twenty-seventh embodiment, the same configuration as the apparatus shown in FIG. 27 is indicated by the same reference numerals, and the detailed description is neglected.

As shown in FIGS. 34 and 35, the radical treatment apparatus of the twenty-seventh embodiment has a ground electrode 80. The ground electrode 80 has the structure in which at least one hole 81 is made, and the ground electrode 80 is arranged in the treatment water 2. The ground electrode 80 is formed by, e.g. one stainless-steel plate, and at least one through-hole 81 is made in the stainless-steel plate 80.

According to the ground electrode 80 of the twenty-seventh embodiment, because the treatment water 2 passes through the hole 81 of the ground electrode 80 to circulate upward and downward, the treatment water 2 is easily stirred. Accordingly, when the decomposition treatment of the organic matter is performed to the treatment water 2 by the corona discharge, the efficiency of the decomposition treatment can be improved to achieve reduction of treatment time.

In the radical treatment apparatus of the twenty-seventh embodiment, as with the twenty-fourth embodiment, because the electric discharge electrode where the corona discharge is generated can be produced at relatively low cost, the practical radical treatment apparatus can easily be provided.

(Twenty-Eighth Embodiment)

FIG. 36 (plan view) is a view for explaining a structure of a ground electrode 90 of a radical treatment apparatus according to a twenty-eighth embodiment of the invention. Because the configuration of the radical treatment apparatus is similar to the configuration shown in FIG. 27 or FIG. 34, the description is neglected.

The ground electrode 90 of the twenty-eighth embodiment includes a circular frame 91 made of, for example, stainless steel and a metal mesh 92 provided in the frame 91.

According to the ground electrode 90 of the twenty-eighth embodiment, because the treatment water 2 passes through gaps of the metal mesh 92 to circulate upward and downward, the treatment water 2 is easily stirred. Accordingly, when the decomposition treatment of the organic matter is performed to the treatment water 2 by the corona discharge, the efficiency of the decomposition treatment can be improved to achieve the reduction of the treatment time.

(Twenty-Ninth Embodiment)

FIG. 37 (plan view) is a view for explaining a structure of a ground electrode 90 of a radical treatment apparatus according to a twenty-ninth embodiment of the invention. Because the configuration of the radical treatment apparatus is similar to the configuration shown in FIG. 27 or FIG. 34, the description is neglected.

The ground electrode 90 of the twenty-ninth embodiment includes the circular frame 91 made of, for example, stainless steel and a plurality of metal wires 93. The metal wires 93 are arrayed in the lengthwise direction and crosswise direction. It is also possible that metal rods be used instead of the metal wires 93.

According to the ground electrode 90 of the twenty-ninth embodiment, because the treatment water 2 passes through gaps of the metal wires 93 to circulate upward and downward, the treatment water 2 is easily stirred. Accordingly, when the decomposition treatment of the organic matter is performed to the treatment water 2 by the corona discharge, the efficiency of the decomposition treatment can be improved to achieve the reduction of the treatment time.

(Modification)

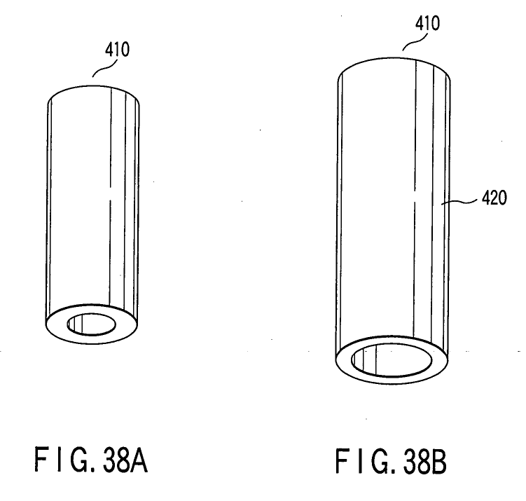

FIGS. 38A and 38B are views showing a modification of the twenty-fourth embodiment, and FIGS. 38A and 38B show the structure of the projection member 410 provided in the first electrode 400.

The projection member 410 shown in FIG. 38A has the hollow cylindrical shape, and the gas 70 flows through the hollow portion. The projection member 410 shown in FIG. 38B has the hollow cylindrical shape, and the surface of the projection member 410 is covered with the dielectric body 420.

(Application Example)

The radical treatment apparatus having the first electrode 400 that generates the electric discharge to the treatment water 2 containing the organic matter is described in the twenty-fourth embodiment. However, the first electrode 400 can be applied not only to the radical treatment apparatus used for the treatment water 2 but also to the radical treatment apparatus used for other treatment objects.

Specifically, the radical treatment apparatus that performs surface treatment of a solid body made of glass and the like as the treatment object can be cited as an example. In the radical treatment apparatus, the ground electrode 3 is arranged in, e.g. a machine on which the solid body is loaded, and the high voltage for the electric discharge is applied between the ground electrode 3 and the first electrode 400.

(Thirtieth Embodiment)

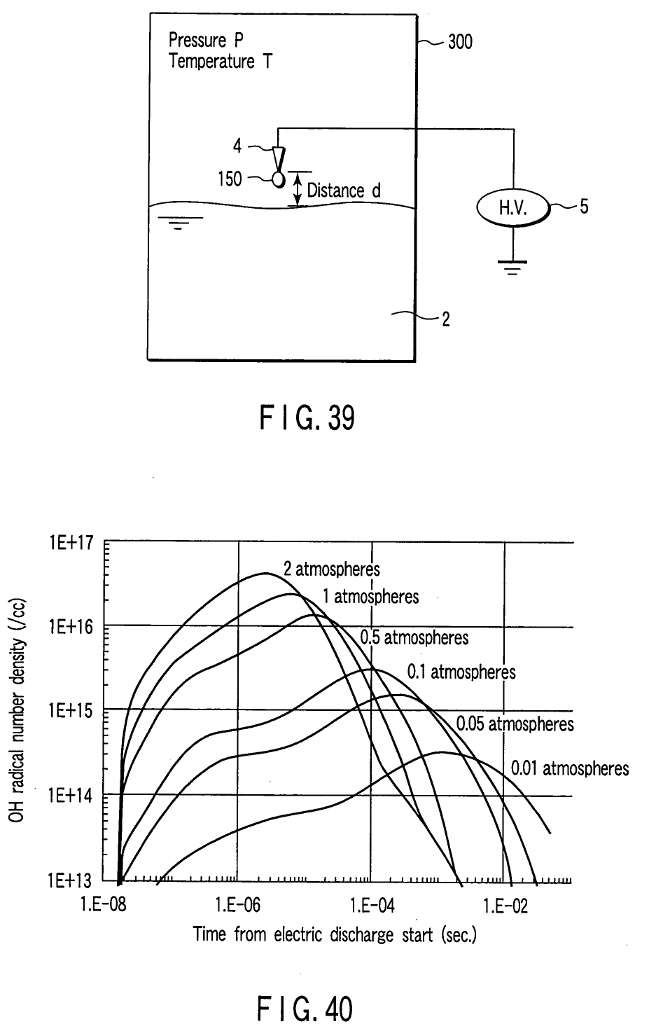

FIG. 39 is a diagram showing a radical treatment apparatus according to a thirtieth embodiment of the invention.

In FIG. 39, the treatment water 2 containing the recalcitrant organic matter, wastes, the leaching water of the disposal site, dioxins, the industrial waste water, and the waste water containing house drainage is stored in a reaction vessel 300. In the gas phase, the electrode 4 to which the high voltage is applied is arranged away from the treatment water 2. It is possible that the plurality of electrodes 4 are arranged depending on the size and the shape of the reaction vessel 300.

The high voltage is applied to the electrode 4 from the high-voltage power supply 5. When the high voltage is applied to the electrode 4, the electrode 4 generates an electric discharge 150.

A part of the electrode 4 is formed in the needle shape or the rod shape, which allows the electric field to concentrate on the part formed in the needle shape or the rod shape. Therefore, the electric discharge can be generated at a low voltage, i.e. the radical can be generated using less energy.

In order to decompose the recalcitrant organic matter dissolved in the treatment water by the OH radical generated from the electric discharge, it is necessary that the radical generated by the electric discharge is dissolved into the water. However, because the radical is very reactive substance, the radical reacts with other particles in a very short time. Therefore, it is necessary that the radical be dissolved into the water immediately after the generation of the radical.

The OH radical is generated from the electric discharge by the following chemical formula. When the electric discharge 150 in the atmosphere containing water vapor and oxygen, in the electric discharge 150, the oxygen atom O(³P) in the ground state and the oxygen atom O(¹D) in the excited state are generated by the collision between the electron e and the gas molecule:
e+O₂→O(¹D)+O(³P) (41)

O(¹D) reacts with the water molecule to generate the OH radical:
O(¹D)+H₂O→2.OH (42)

O(³P) generates ozone (O₃) by the triple collision of O(³P), O₂, and the neutral molecule M:
O(³P)+O₂+M→O₃+M (43)

The hydrogen atom and the OH radical are also generated by the direct collision of the water molecule and the electron:
e+H₂O→H+OH. (44)

Thus, the generated OH radical has a traveling rate depending on the temperature and the pressure, and the OH. is dissolved into the treatment water. However, the OH radical has high oxidation power, and the OH radical reacts with other particles in a short time. Namely, in order to use the OH radical for the water treatment, it is necessary that the OH radical is dissolved into the treatment water before the OH radical reacts with other particles.

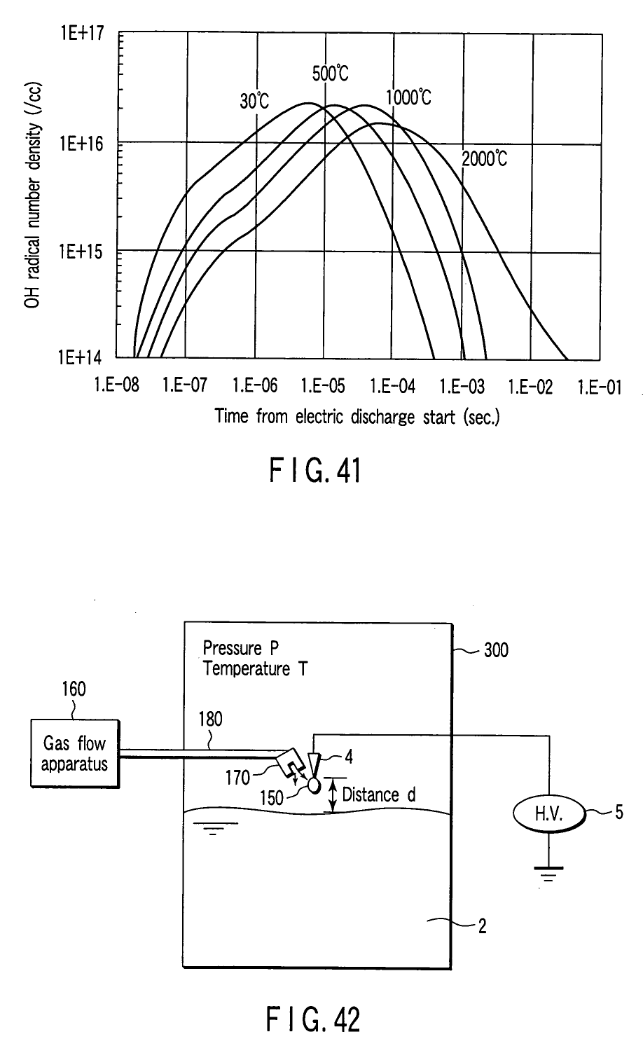

Assuming that the time from the generation of the OH radical to the reaction with other particles is the life, temperature dependence of the life of the OH radical is shown in FIG. 41. There is no temperature dependence of the maximum value of the OH radical concentration generated from the electric discharge. As the temperature is increased, the high-concentration state becomes longer. Namely, the life of the OH radical is lengthened in proportional to the increase in temperature.

FIG. 40 shows pressure dependence of the change in OH radical concentration. As the pressure is increased, the maximum value of the amount of generation is increased. However, the life of the OH radical is lengthened as the pressure is decreased. In the case of the generation of the electric discharge, the electric discharge can be ignited using lower energy as the pressure is decreased. Therefore, as the temperature is increased or as the pressure is decreased, the life of the OH radical is increased and the higher generation efficiency of the OH radical can be expected.

As shown in chemical formulas (42) and (44), when the electric discharge is ignited in the vapor atmosphere, the OH radical is generated. In the case where the vapor is generated with a steam boiler, although based on conditions, the temperature is limited to about one thousand and several hundreds degrees Celsius.

In the case where the further higher temperature is generated, the temperature can be increased up to thousand degrees Celsius by generating arc discharge, and temperature control can be performed by adjusting injection electric power to the arc discharge. However, since it is thought that the treatment water is boiled, the increase in temperature is limited to a certain value. Namely, in the case where the radical treatment of the water is industrially performed, it is said that the temperature of the radical treatment ranges from room temperature to one thousand and several hundreds degrees Celsius.

FIG. 41 shows the life of the OH radical in the conditions. As can be seen from FIG. 41, in the case where the treatment atmospheric temperature is two thousand degrees Celsius, almost all the OH radicals remain even when the 10 ms elapses from the ignition of the electric discharge.

As described above, the OH radical is generated when the electric discharge is ignited in the high-humidity atmosphere. In the case where the humidity is 100%, a ratio of the water molecule that occupies the space is about 1% in the atmospheric pressure.

FIG. 40 shows the pressure dependence of the life of the OH radical when the electric discharge is generated in the gas in which the humidity becomes 100%. As can be seen from FIG. 40, when the pressure is decreased to about 0.01 atmospheres almost all the OH radicals remain even when the 10 ms elapses from the ignition of the electric discharge.

When all the molecules except for the water molecule are removed from the gas having the humidity of 100% in the atmospheric pressure, the gas contains only the water molecule in the pressure of 0.01 atmospheres. Therefore, in consideration of industrial application, it is desirable that the lower limit of the pressure range is up to about 0.01 atmospheres.

Thus, it is understood that the life of the OH radical is lengthened as the temperature is increased or as the pressure is decreased. In order to perform the water treatment by the OH radical, it is necessary that the OH radical be dissolved into the treatment water during the time when the OH radical exists.

The OH radical generated from the electric discharge reaches the surface of the treatment water by the diffusion. Traveling distance 8 of the OH radical by the diffusion can be expressed by the following equation using a diffusion constant D, a traveling time t, a temperature T, and a pressure P:
δ=(2Dt)^{1/2} (45)
D=5.4×10⁻⁴×T^{3/2}/P (46)
Namely,
t=P×d²/(T^{3/2}×1.08×10⁻³) (47)

As can be seen from FIGS. 40 and 41, the extinction time of the OH radical is lengthened as the pressure is decreased or as the temperature is increased. In consideration of the extinction time obtained FIGS. 40 and 41, the following expression is obtained from the equation (47):
P×d²<(T^{5/4}×10⁻⁶) (48)

In the expression (48), the temperature T is the room temperature, the pressure P is 50 torr (0.065 atmosphere), and the distance d between the electrodes is not more than 1.3 cm. It is possible that the temperature T is 1500° C., the pressure P is the atmospheric pressure, and the distance d between the electrodes is not more than 1 mm. Preferably the temperature T is set to 1500° C., the pressure P is set to 50 torr, and the distance d between the electrodes is set to a value not more than 3.78 cm. Therefore, the OH radical can treat the treatment water.

In the radical treatment apparatus having the distance d between the surface of the treatment water and the electrode discovered by the expression (48), the OH radical generated from the electric discharge is dissolved into the treatment water, and the OH radical reacts with the recalcitrant organic matter to be resolved into the water H₂O, carbon dioxide CO₂, and hydrogen peroxide:
OH.+R→H₂O+CO₂+H₂O₂ (49)

Unlike the conventional ozone treatment, the radical treatment can decompose the recalcitrant organic matter into inorganic matter.

It is possible that any one of an alternating-current power supply, a direct-current power supply, and the pulse power supply is used as the high-voltage power supply 5. When the alternating-current power supply is used as the power supply 5, the electric power can efficiently be injected to the electric discharge through a water layer, so that the decomposition efficiency of the recalcitrant organic matter can be improved. When the direct-current power supply is used as the power supply 5, the electric discharge can efficiently be ignited in the gas phase, so that the decomposition efficiency of the recalcitrant organic matter can be improved.

When the pulse power supply used as the power supply 5, the high energy can be injected to the electric discharge in a short time, so that the radical generation efficiency can be improved. Further, since the discharge time per pulse is short, the injection energy to the electric discharge is not used for the increase in temperature caused by Joule heating of the discharge space but the injection energy is substantially used for the generation of the radical. Therefore, the decomposition efficiency of the recalcitrant organic matter can be improved.

(First Modification)

FIG. 42 is a diagram showing a first modification of the thirtieth embodiment. In the first modification, the treatment water 2 is also stored in the reaction vessel 300. In the gas phase, the electrode 4 to which the high voltage is applied is arranged away from the treatment water 2. The same configuration as the apparatus shown in FIG. 39 is indicated by the same reference numeral, and the detail description is neglected.

The gas generated from a gas flow apparatus 160 is blown to the electric discharge from a gas-blowing device 170 through a gas guide 180. The gas-blowing device 170 is arranged so that the radical generated from the electrode 4 is guided to the treatment water 2, and the gas-blowing device 170 is formed by, e.g. a nozzle. The gas generated from the gas flow apparatus 160 is one that contains oxygen. For example, the gas generated from the gas flow apparatus 160 is the water vapor.

As described above, the life of the OH radical is short, and the traveling distance by the diffusion is short. In order to solve the problem, the gas blown from the gas flow apparatus 160 forcedly moves the O radical and OH radical that is generated by the electric discharge to the surface of the treatment water. At this point, in a gas flow rate V, in consideration of the OH radical extinction time obtained from FIGS. 40 and 41, d/V is determined not more than 1 ms. Therefore, in addition to the traveling by the diffusion, the radical travels by the gas flow, so that the radical can be delivered to the treatment water within the lives of the O radical and OH radical. As a result, the efficiency of the decomposition treatment can be improved.

In FIG. 42, it is possible that the pluralities of electrodes 4 are arranged depending on the size and the shape of the reaction vessel 300. The high voltage is applied to the electrode 4 from the high-voltage power supply 5. When the high voltage is applied to the electrode 4, the electrode 4 generates an electric discharge 150.

(Second Modification)

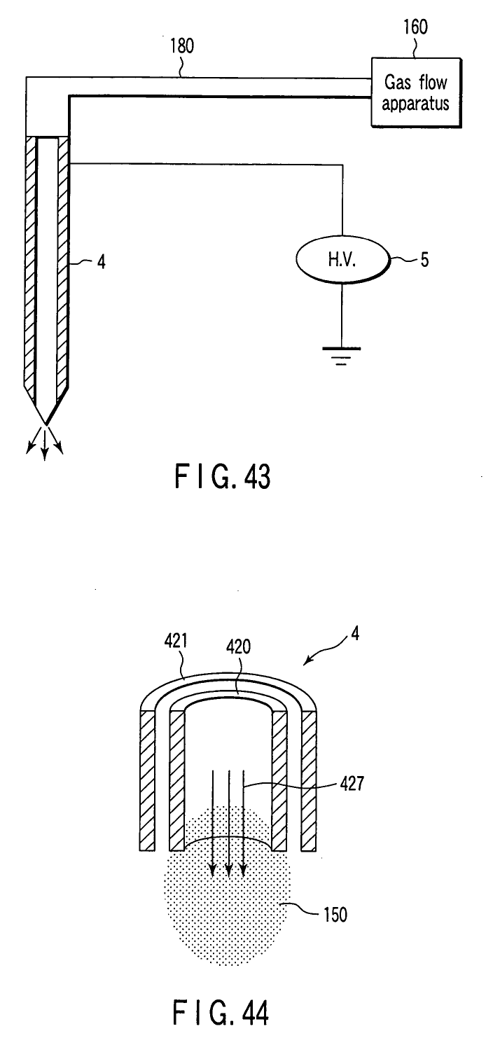

FIG. 43 is a diagram showing a first modification of the thirtieth embodiment. The same configuration as the apparatus shown in FIG. 39 is indicated by the same reference numerals, and the detailed description is neglected.

The electrode 4 is formed in a hollow shape, the electrode 4 and the gas flow apparatus 160 are connected to each other through the gas guide 180. The gas containing oxygen, which generated from the gas flow apparatus 160, flows in the inside of the electrode 4 through the gas guide 180. The gas flows in the inside of the electrode 4, which allows the O radical and the OH radical which are generated from the electric discharge 150 to forcedly be moved to the surface of the treatment water. In the case where the gas is the water vapor, when the gas flows in the inside of the electrode 4, the amount of generation of the OH radical is remarkably increased, which allows the decomposition treatment of the recalcitrant organic matter to be performed.

Thus, according to the modification of the thirtieth embodiment, the electrode 4 has the hollow shape, when the gas flows in the inside of the electrode 4, the discharge energy can be substantially injected into the gas. The OH radical generation efficiency is increased by causing the gas which is easily generates the OH radical to flow the inside of the electrode 4, which allows the decomposition efficiency of the recalcitrant organic matter to be improved.

(Third Modification)

FIG. 44 is a sectional view showing a third modification of the thirtieth embodiment. The same configuration as the apparatus shown in FIG. 39 is indicated by the same reference numerals, and the detailed description is neglected.

As shown in FIG. 44, the feature of the third modification is that the electrode 4 is formed in a double-pipe structure. The inner pipe 420 of the electrode 4 and the gas guide (not shown) are connected to each other, and the gas generated from the gas flow apparatus to flow in the inner pipe 420 of the electrode 4.

In order to obtain heat insulation effect from the outside of the electrode, an outer pipe 421 is provided around the inner pipe 420, so that delivered has temperature can become constant. As a result, the life of the radical is lengthened, and the water treatment can effectively be performed.

(Fourth Modification)

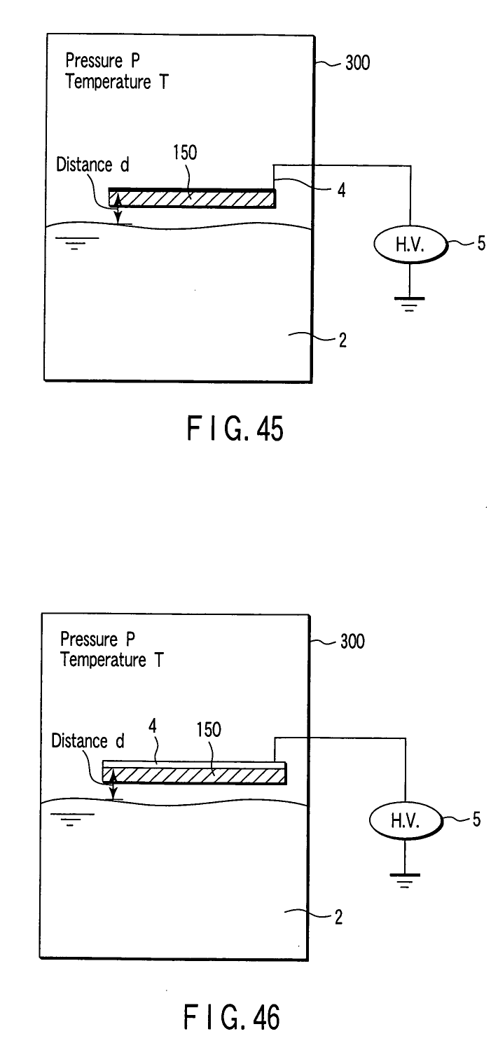

FIG. 45 is a sectional view showing a fourth modification of the thirtieth embodiment. The same configuration as the apparatus shown in FIG. 39 is indicated by the same reference numerals, and the detailed description is neglected.

As shown in FIG. 45, the feature of the fourth modification is that the electrode 4 is formed by the linear electrode and the electrode 4 is arranged opposite to the treatment water 2. The electric field strength concentrates along the electrode 4 by forming the electrode in the linear shape, and the electric discharge is generated at a low voltage. Further, the radical generation efficiency is increased, and a length or the shape of the electrode can be changed according to the shape of the reaction vessel 300. Therefore, the fourth modification is effective to the water treatment.

The electric discharge can be generated in the wide range by providing the linear electrode 4 which is arranged opposite to the treatment water, so that the decomposition efficiency of the organic matter can be improved.

(Fifth Modification)

FIG. 46 is a sectional view showing a fifth modification of the thirtieth embodiment. The same configuration as the apparatus shown in FIG. 39 is indicated by the same reference numerals, and the detailed description is neglected.

The feature of the fifth modification is that the electrode 4 is formed in the plate shape and the electrode 4 is arranged parallel to the treatment water 2. The electric discharge can be generated in the wide area with respect to the surface of the treatment water 2 by forming the electrode 4 in the plate shape, so that the generation efficiency of the O radical and the OH radical is improved and the high water treatment efficiency is obtained.

(Sixth Modification)

The feature of the sixth modification is that the periphery of the electrode 4 is covered with the dielectric body.

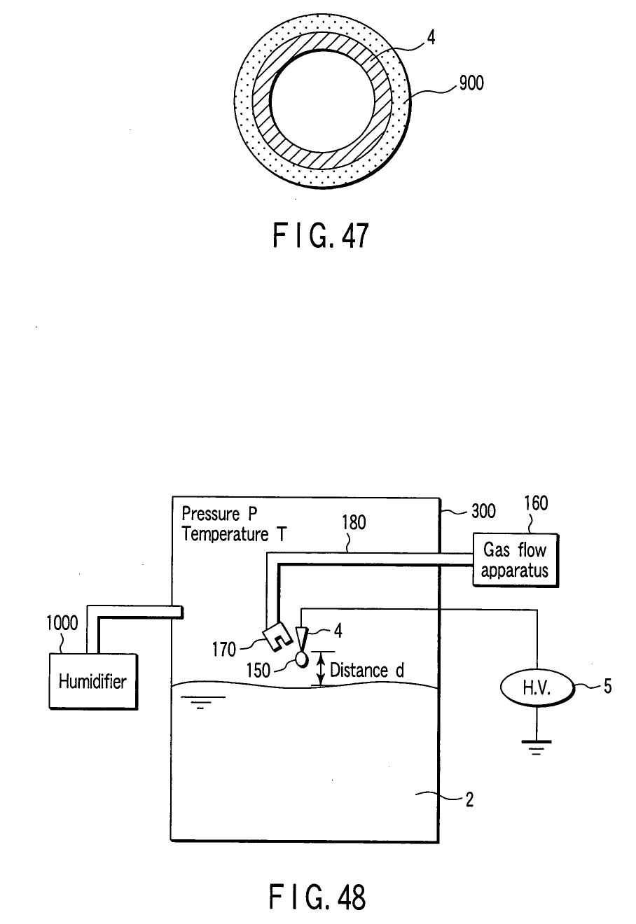

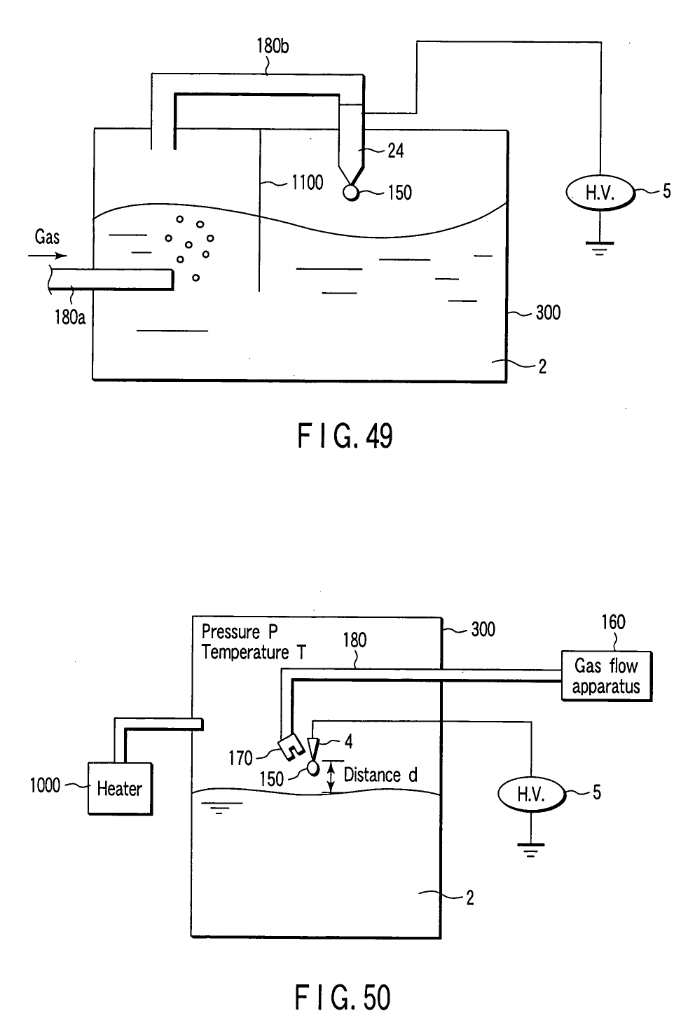

FIG. 47 is a sectional view showing a sixth modification of the thirtieth embodiment. FIG. 49 shows the case in which the surface of the hollow electrode 4 is covered with a dielectric body 900. The same configuration as the apparatus shown in FIG. 39 is indicated by the same reference numerals, and the detailed description is neglected.

When the electrode 4 is covered with the dielectric body, not only secondary contamination of the treatment water caused by dissolving the electrode material by the electric discharge is prevented, but also numerous micro-discharges are generated when the alternating-current voltage is applied, so that the micro-discharge can stably and evenly be obtained in the electric discharge space. As a result, the generation efficiency of the O radical and the OH radical can be improved, and the decomposition efficiency of the organic matter can be improved.

(Seventh Modification)

FIG. 48 is a diagram showing a seventh modification of the thirtieth embodiment. The same configuration as the apparatus shown in FIGS. 39 and 42 is indicated by the same reference numerals, and the detailed description is neglected. The feature of the seventh modification is that a humidifier 1000 is provided in order to increase the humidity in the reaction vessel 300.

In FIG. 48, the treatment water 2 is stored in the reaction vessel 300. In the gas phase, the electrode 4 to which the high voltage is applied is arranged away from the treatment water 2. The humidifier 1000 is provided in order to increase the humidity in the reaction vessel 300. The humidifier 1000 humidifies the inside of the reaction vessel 300 so that condensation is not generated in the reaction vessel 300, which results in the increase in humidity during the electric discharge. Therefore, the generation efficiency of the O radical and the OH radical can be improved, and the decomposition efficiency of the organic matter can be improved.

In FIG. 48, the humidifier 1000 is provided while separated from the reaction vessel 300. However the structure of the humidifier 1000 is not limited to FIG. 48.

FIG. 49 shows an example of the other humidifiers. As shown in FIG. 49, the reaction vessel 300 is separated by the partition 1100 to provide a gas guide 180a that exhausts the gas into the treatment water 2. Further, a gas guide 180b is provided in order to pass the gas to the electrode 4. The gas passes through the treatment water 2 to contain the humidity.

According to the humidifier having the above-described structure, since the reaction vessel 300 is also used as the humidifier, the radical treatment apparatus can be miniaturized.

(Eighth Modification)

FIG. 50 is a diagram showing an eighth modification of the thirtieth embodiment. The same configuration as the apparatus shown in FIGS. 39, 42, and 48 is indicated by the same reference numerals, and the detailed description is neglected. The feature of the eighth modification is that a heater 1060 is provided in order to increase the temperature in the reaction vessel 300.

In FIG. 50, the treatment water 2 is stored in the reaction vessel 300. In the gas phase, the electrode 4 to which the high voltage is applied is arranged away from the treatment water 2. The heater 1060 is provided in order to increase the temperature in the reaction vessel 300, which results in the temperature increase during the electric discharge. Therefore, the diffusion rate of the O radical and the OH radical can be improved, and the decomposition efficiency of the organic matter can be improved.

(Ninth Modification)

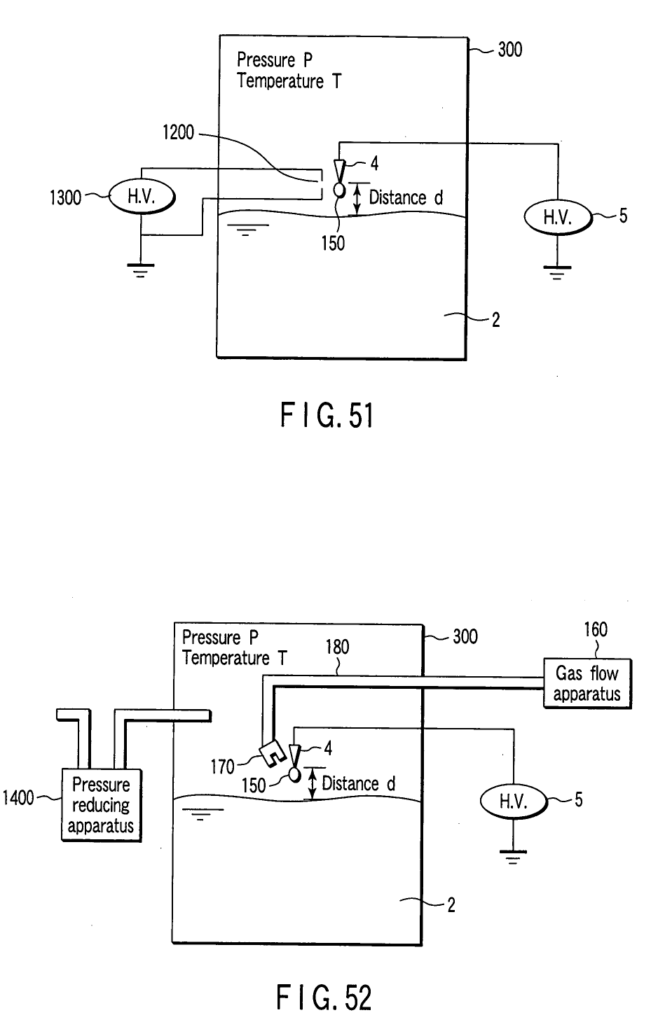

FIG. 51 is a diagram showing a ninth modification of the thirtieth embodiment. The same configuration as the apparatus shown in FIG. 39 is indicated by the same reference numerals, and the detailed description is neglected.

In FIG. 51, the treatment water 2 is stored in the reaction vessel 300. In the gas phase, the electrode 4 to which the high voltage is applied is arranged away from the treatment water 2. In the reaction vessel 300, an arc discharge electrode 1200 is provided, and an arc discharge power supply 1300 is also provided in order to generate the arc discharge.

When the arc discharge is generated in the reaction vessel 300, the temperature is increased in the electric discharge portion by the heat generation effect of the arc discharge, which allows the diffusion rate of the O radical and the OH radical generated from the electric discharge 150 to be increased. Further, the oxygen atom is generated from the arc discharge in the atmosphere containing oxygen. Therefore, the generation efficiency of the O radical and the OH radical is improved, and the decomposition efficiency of the recalcitrant organic matter is improved.

(Tenth Modification)

FIG. 52 is a diagram showing a tenth modification of the thirtieth embodiment. The same configuration as the apparatus shown in FIGS. 39 and 42 is indicated by the same reference numerals, and the detailed description is neglected.

In FIG. 52, the treatment water 2 is stored in the reaction vessel 300. In the gas phase, the electrode 4 to which the high voltage is applied is arranged away from the treatment water 2. A pressure reducing apparatus 1400 is provided in order to reduce the pressure in the reaction vessel 300, which allows the diffusion rate of the O radical and the OH radical generated from the electric discharge to be increased. Therefore, because the amount of dissolution of the generated radical into the treatment water is increased, the decomposition efficiency of the recalcitrant organic matter can be improved.

(Eleventh Modification)

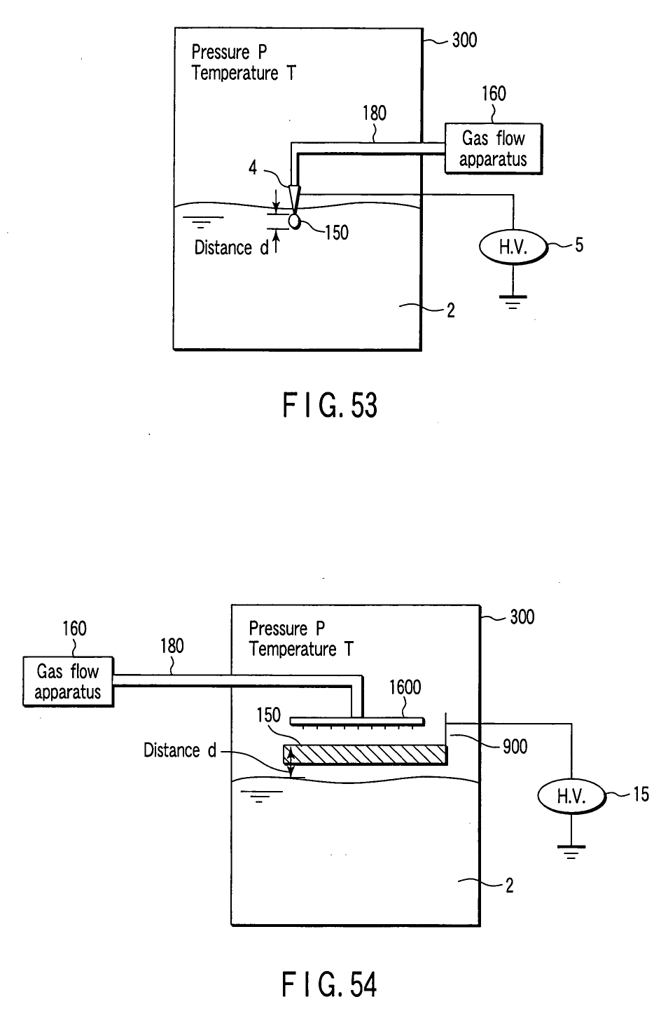

FIG. 53 is a diagram showing an eleventh modification of the thirtieth embodiment. The same configuration as the apparatus shown in FIG. 39 is indicated by the same reference numerals, and the detailed description is neglected. The feature of the eleventh modification is that a part of the electrode 4 is located in the treatment water 2.

In FIG. 53, the treatment water 2 is stored in the reaction vessel 300. The electrode 4 to which the high voltage is applied is arranged in the treatment water 2, the gas supplied through the gas guide 180 is blown from the leading edge of the electrode 4.

A part of the electrode 4 is arranged in the treatment water 2, bubbles 150 are generated into the water by blowing the gas from the electrode 4. The diameter of the generated bubble is controlled so that d/V is not more than 1 ms, where d (m) is the distance between the water surface of the treatment water s and the electrode 4 and V (m/s) is the gas flow rate. It is possible that the gas is blown to the leading edge of the electrode 4 from the outside with the gas-blowing device. Therefore, the treatment of the recalcitrant organic matter is enabled.

(Twelfth Modification)

FIG. 54 is a diagram showing a twelfth modification of the twelfth embodiment. The same configuration as the apparatus shown in FIGS. 39 and 42 is indicated by the same reference numerals, and the detailed description is neglected. The feature of the twelfth modification is that a blowing device 1600 is provided. The gas-blowing device 1600 blows the gas, which is supplied from the gas flow apparatus 160 through the gas guide 180, to a linear electrode 900.

The electric discharge can be generated in the wide area by providing the gas-blowing device 1600, and the shape of the electrode is easily changed, so that the shape of the electrode can be fitted to the shape of the reaction vessel. The O radical and the OH radical generated from the electric discharge are dissolved into the treatment water by the gas blown with the gas blowing device 1600, so that the treatment of the recalcitrant organic matter is enabled.

(Thirteenth Modification)

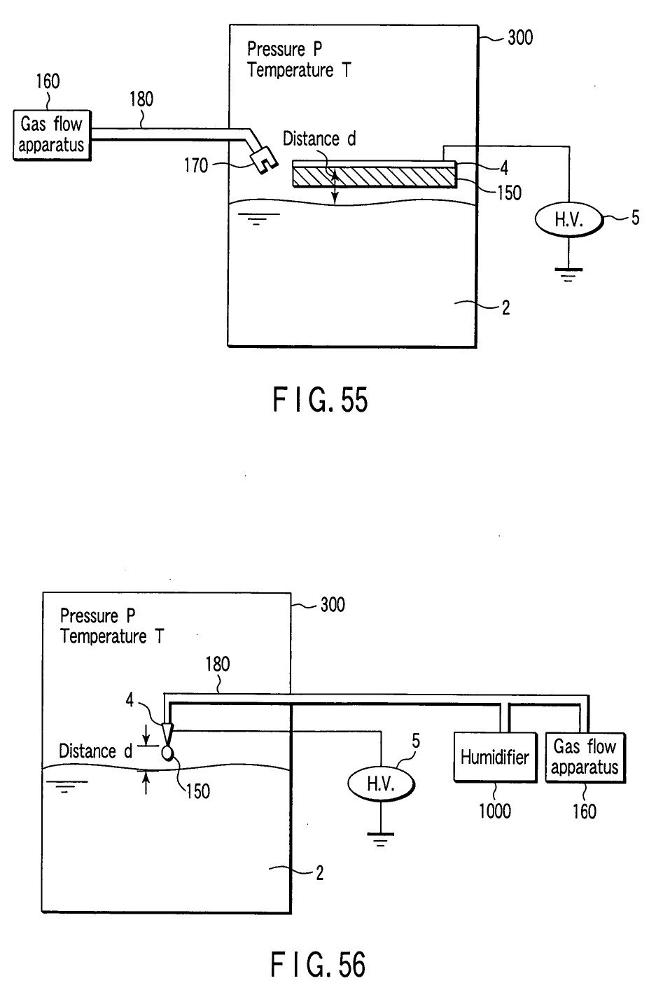

FIG. 55 is a diagram showing a thirteenth modification of the thirtieth embodiment. The same configuration as the apparatus shown in FIGS. 39 and 42 is indicated by the same reference numerals, and the detailed description is neglected. The feature of the thirteenth modification is that a blowing device 170 is provided. The blowing device 170 blows the gas, which is supplied from the gas flow apparatus 160 through the gas guide 180, to the plate-shaped electrode 4.

The electric discharge can be generated in the wide area by providing the blowing device 170, and the shape of the electrode is easily changed, so that the shape of the electrode can be fitted to the shape of the reaction vessel. The O radical and the OH radical generated from the electric discharge are dissolved into the treatment water by the gas blown with the blowing device 170, so that the treatment of the recalcitrant organic matter is enabled.

(Fourteenth Modification)

FIG. 56 is a diagram showing a fourteenth modification of the thirtieth embodiment. The same configuration as the apparatus shown in FIGS. 39, 42, and 48 is indicated by the same reference numerals, and the detailed description is neglected. The feature of the fourteenth modification is that the humidifier 1000 is provided in addition to the gas flow apparatus 160 that supplies the gas to the gas guide 180. The humidifier 1000 delivers the vapor in order to increase the humidity in the reaction vessel 300.

The vapor is delivered into the reaction vessel 300 in order to increase the humidity in the reaction vessel 300. At this point, both the vapor and the gas containing oxygen gas are delivered from the gas flow apparatus 160, which allows the generation efficiency of the OH radical and the O radical to be improved. Therefore, the decomposition efficiency of the recalcitrant organic matter is improved.

(Fifteenth Modification)

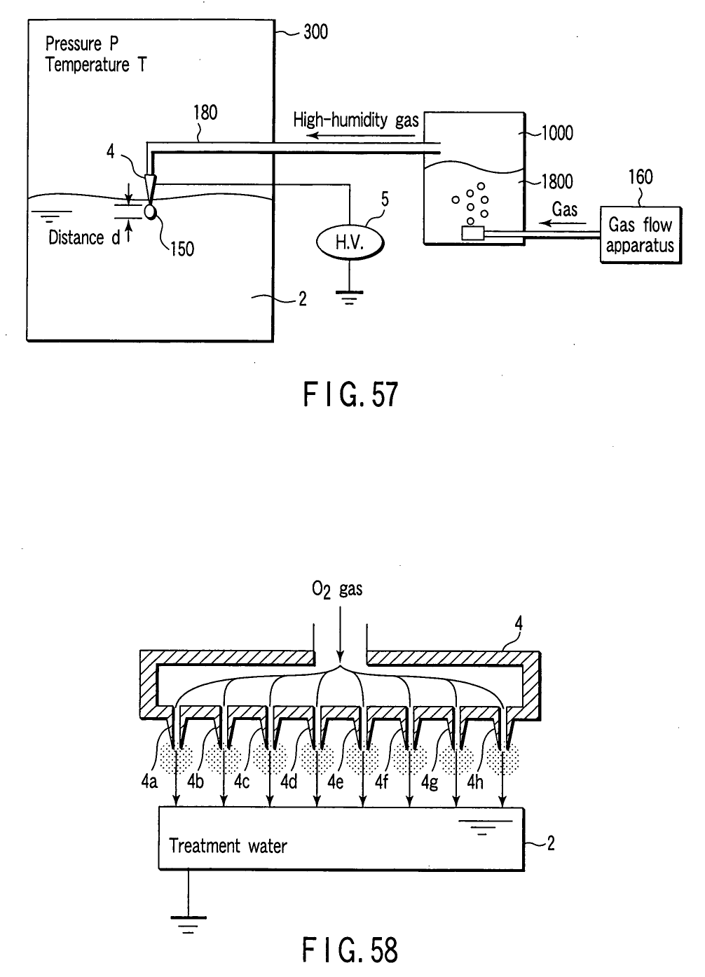

FIG. 57 is a diagram showing a fifteenth modification of the thirtieth embodiment. The feature of the fifteenth modification includes a method for combining the gas flow apparatus 160 and the humidifier 1000. The same configuration as the apparatus shown in FIGS. 48 and 53 is indicated by the same reference numerals.

As shown in FIG. 57, the gas containing oxygen, which generated in the gas flow apparatus 160, is exhausted into a liquid 1800 stored in the humidifier 1000 through the gas guide 180. The humidified gas passes through the liquid 1800, the humidified gas passes through the electrode 4 through the gas guide 180, and then the humidified gas is exhausted into the treatment water 2.

Therefore, the same effect as the fourteenth modification can be obtained.

(Sixteenth Modification)

FIG. 58 is a sectional view showing a sixteenth modification of the thirtieth embodiment. The same configuration as the apparatus shown in FIG. 42 is indicated by the same reference numerals.

As shown in FIG. 58, the electrode 4 is formed in the hollow structure, and hollow electrodes 4a to 4h having the structure shown in FIG. 43 are provided in the hollow portion of the electrode 4. The plurality of hollow electrodes 4a to 4h of FIG. 43 is shown in the sixteenth modification by way of illustration. The case in which the pluralities of electrodes shown in other modifications exist also included in the sixteenth modification.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An apparatus for radical treatment comprising:
a gas unit to introduce gas for generating a radical;
a power supply which generates high voltage to produce electric discharge; and
an electrode unit to occur electric discharge; the electric discharge is occurred at the tip of electrodes surrounded by atmospheric pressure by applied high voltage from the power supply.

2. The apparatus according to claim 1, further comprising a water tank to store the treatment water, wherein the electrodes have gas flow paths for blowing the gas onto the water surface, and the electric discharge is occurred at the tip of electrodes where the gas is blown through the gas.

3. The apparatus according to claim 1, further comprising a gas tank in which the gas is stored, wherein the gas unit introduces the gas from the gas tank.

4. The apparatus according to claim 2, further comprising a gas tank in which the gas is stored, wherein the gas unit introduces the gas from the gas tank and the gas is taken in the gas flow path.

5. The apparatus according to claim 1, wherein the power supply is a pulse power supply which generates a high-voltage pulse.

6. The apparatus according to claim 1, wherein the gas is gas which contains a water molecule and an oxygen molecule.

7. The apparatus according to claim 1, wherein the electrode unit is structured by at least more than one hollow cylindrical electrode, the hollow portion forms the gas flow path, and the electric discharge is occurred at the tip of cylindrical electrode.

8. The apparatus according to claim 1, wherein the electrode has a structure whose periphery is covered with a dielectric member.

9. The apparatus according to claim 2, wherein the electrode has a structure in which a periphery of a main body including the gas flow path and the leading edge is covered with the dielectric member.

10. The apparatus according to claim 1, wherein the electrode unit includes two faced electrodes, one is a high voltage electrodes of needle structure, another is an earth electrode of plate structure with hole,
the discharge from the edge of the first electrode according to high voltage applied from the power supply between the first electrode member and the second electrode member, and
the electrode unit has a structure in which both the gas flowing from the opening to the treatment object matter and the radical generated by the electric discharge are supplied to the recalcitrant organic matter in treatment water.

11. The apparatus according to claim 1, wherein the electrode unit has the first electrode member having a metal mesh structure and the second plate-shaped electrode member having the opening, as the electrode member, and
the electrode unit has a structure in which the electric discharge is generated from the first electrode according to the high voltage applied from the power supply between the first electrode member and the second electrode member.

12. The apparatus according to claim 1, wherein the electrode unit has a first plate-shaped metal electrode and a plate-shaped second electrode member having an opening, as the electrode member, and
the electrode unit has a structure in which the electric discharge is generated from the first electrode member according to the high voltage applied from the power supply between the first electrode member and the second electrode member.

13. The apparatus according to claim 1, wherein the electrode unit has the first plate-shaped electrode member having a first opening and the plate-shaped second electrode member having a second opening and is arranged in parallel with the first electrode member, as the electrode member,
the electrode unit discharges from the first electrode member according to high voltage applied from the power supply between the first electrode member and the second electrode member, and
the electrode unit has a structure in which both the gas flowing from the first and second openings to the treatment object matter and the radical generated by the electric discharge are supplied to the treatment object matter.

14. The apparatus according to claim 12, wherein the electrode unit has the dielectric member that is provided between the first and second electrode members.

15. The apparatus according to claim 12, wherein the first electrode member of electrode unit has a wire structure.

16. The apparatus according to claim 1, wherein the electrode unit has a first electrode whose edge is formed in the needle shape and a second plate-shaped electrode which is provided opposite to the leading edge, and a dielectric member which forms a hollow portion while having an axis of the first electrode member, as the electrode member,
the electrode unit discharges from the leading edge of the first electrode member according to high voltage applied from the power supply between the first electrode member and the second electrode member, and
the electrode unit has the structure in which both the gas flowing toward the treatment object matter through the hollow portion and the radical generated by the electric discharge are supplied to the treatment object matter.

17. The apparatus according to claim 16, wherein the second electrode member has an opening.

18. The apparatus according to claim 1, wherein the second electrode member has a metal mesh structure.

19. The apparatus according to claim 1, wherein the electrode unit has a first electrode member and a second electrode member to which the high voltage is applied from the power supply, as the electrode member, and
the electrode unit has a structure in which a hollow portion including the first electrode member and the second electrode member is formed, the electric discharge is generated in the hollow portion, and the gas is supplied to the treatment object matter through the hollow portion.

20. The apparatus according to claim 1, wherein the corona discharge is produced at the tip of electrode unit.

21. The apparatus according to claim 1, further comprising control means for controlling the high-voltage pulse provided from the power supply to the electrode unit, the control means performing control in a voltage-power characteristic of the electric discharge so that a process is performed in such an electric discharge power range that voltage is increased as current is increased and a ratio (dV/dI) of a voltage increment dV and a current increment dI is increased as a current value is increased.

22. The apparatus according to claim 1, wherein the electrode unit has at least one projection to produce discharges at the tip of projection to which the electric discharge high voltage is applied.

23. The apparatus according to claim 22, wherein the leading edge of the projection member is formed in a circular cone or a pyramid while being opposite to the treatment object matter.

24. The apparatus according to claim 22, wherein the leading edge of the projection member is formed in the needle while being opposite to the treatment object matter.

25. The apparatus according to claim 22, further comprising a ground electrode that is connected to a ground side of the power supply,
Wherein the electrode member is configured so that the high voltage is applied between the ground electrode and the electrode member to produce the electric discharge from the projection member.

26. The apparatus according to claim 22, wherein the electrode member has a structure in which the projection member is formed from a main body.

27. The apparatus according to claim 22, wherein the electrode member has a structure in which the projection member is formed from one metal plate.

28. The apparatus according to claim 22, wherein the electrode member has a structure in which the projection member is formed by cutting the one metal plate.

29. The apparatus according to claim 22, wherein the electrode member has a structure in which a metal projection portion and the periphery of the projection portion of the projection member are covered with a dielectric material.

30. The apparatus according to claim 25, wherein the ground electrode is a metal plate.

31. The apparatus according to claim 25, wherein the ground electrode has a structure in which at least one hole is made in a plane of a metal plate.

32. The apparatus according to claim 25, wherein the ground electrode has a structure in which a metal mesh surface is provided in a metal frame.

33. The apparatus according to claim 25, wherein the ground electrode has a structure in which at least one metal wire or metal rod is provided in the metal frame.

34. The apparatus according to claim 25, wherein the treatment object matter is stored in a water tank, the electrode member is provided in the water tank, and
the ground electrode has a structure in which the ground electrode is arranged in the water tank.

35. The apparatus according to claim 1, wherein the treatment object matter is solid matter, and
the electrode unit is configured so that the electric discharge is generated from the electrode member in order to perform surface treatment of the solid matter.
